(19) United States
(12) Patent Application Publication
(10) Pub. No.: US 2015/0211950 A1
(43) Pub. Date: Jul. 30, 2015

(54) METHODS, SYSTEMS, AND DEVICES FOR POSITIVE PRESSURE PHARMACEUTICAL VIALS

(71) Applicant: TOKITAE LLC, Bellevue, WA (US)

(72) Inventors: Philip A. Eckhoff, Kirkland, WA (US); Muriel Y. Ishikawa, Livermore, CA (US); Nels R. Peterson, Bellevue, WA (US); Lowell L. Wood, JR., Bellevue, WA (US); Victoria Y. H. Wood, Livermore, CA (US)

(73) Assignee: TOKITAE LLC,

(21) Appl. No.: 14/167,854

(22) Filed: Jan. 29, 2014

(51) Int. Cl. G01L 19/08; B65B 7/16; B65C 3/06; B65D 41/00; A61J 1/06; A61J 1/14; A61J 1/18; B65D 25/20; B65B 3/00; B65B 31/08

(52) U.S. Cl. CPC G01L 19/08; B65B 3/003; B65B 7/161; B65C 3/06; B65B 31/08; A61J 1/065; A61J 1/1406; A61J 1/1412; A61J 1/18; B65D 25/205; B65D 41/005; A61J 2200/70

(57) ABSTRACT

Methods, systems, and devices are described for calculating a push pressure for a pharmaceutical vial with a syringe, the method including accepting data regarding at least one parameter of the pharmaceutical vial, at least one parameter of a vial cap with a seal, at least one parameter of the syringe, and a single dose volume of a liquid pharmaceutical; calculating a volume of headspace over the liquid pharmaceutical with a computing device; calculating an ejection pressure based on the single dose volume of the liquid pharmaceutical and the volume of headspace; calculating a motive pressure based on a static force and a cross-sectional area of the syringe; defining the push pressure as the greater of the ejection pressure or the motive pressure; and reporting the push pressure to a user. The method further includes calculating a molar amount of inert gas needed in the pharmaceutical vial to generate the calculated push pressure.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

NONE

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

In an aspect, a method of calculating a push pressure of a pharmaceutical vial with a syringe includes, but is not limited to, accepting data including at least one parameter of the pharmaceutical vial, the at least one parameter of the pharmaceutical vial including an internal volume of the pharmaceutical vial; accepting data including a single dose volume of a liquid pharmaceutical; accepting data including at least one parameter of a vial cap with a seal, the at least one parameter of the vial cap with the seal including a volume of the vial cap; calculating a volume of headspace over the single dose volume of the liquid pharmaceutical with a computing device; calculating an ejection pressure with the computing device based on the single dose volume of the liquid pharmaceutical and the volume of headspace; accepting data including at least one parameter of the syringe, the at least one parameter of the syringe including a static force and a cross-sectional area of the syringe; calculating a motive pressure with the computing device based on the static force and the cross-sectional area of the syringe; defining the push pressure as the greater of the ejection pressure or the motive pressure; and reporting the push pressure to a user. In an aspect, the method further includes, but is not limited to selecting an inert gas for filling the volume of headspace; calculating a molar amount of the inert gas for filling the volume of headspace sufficient to generate the push pressure; and reporting the molar amount of the inert gas to the user. In addition to the foregoing, other method aspects are described in the claims, drawings, and text forming a part of the present disclosure.

In an aspect, circuitry for calculating a push pressure of a pharmaceutical vial with a syringe includes, but is not limited to, circuitry for accepting data including at least one parameter of the pharmaceutical vial, the at least one parameter of the pharmaceutical vial including an internal volume of the pharmaceutical vial; circuitry for accepting data including a single dose volume of a liquid pharmaceutical; circuitry for accepting data including at least one parameter of a vial cap with a seal, the at least one parameter of the vial cap with the seal including a volume of the vial cap; circuitry for calculating a volume of headspace over the single dose volume of the liquid pharmaceutical; circuitry for calculating an ejection pressure based on the single dose volume of the liquid pharmaceutical and the volume of headspace; circuitry for accepting data including at least one parameter of the syringe, the at least one parameter of the syringe including a static force and a cross-sectional area of the syringe; circuitry for calculating a motive force based on the static force and the cross-sectional area of the syringe; circuitry for defining the push pressure as the greater of the ejection pressure or the motive pressure; and circuitry for sending a signal to report the push pressure to a user. In an aspect, the circuitry further includes circuitry for selecting an inert gas for filling the volume of headspace; circuitry for calculating a molar amount of the inert gas for filling the volume of headspace sufficient to generate the push pressure; and circuitry for sending a signal to report the molar amount of the inert gas to the user. In addition to the foregoing, other circuitry aspects are described in the claims, drawings, and text forming a part of the present disclosure.

In an aspect, a method of filling a pharmaceutical vial includes, but is not limited to, accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal; filling the recommended pharmaceutical vial with the predetermined single dose volume of liquid pharmaceutical; injecting the predetermined molar amount of inert gas into a volume of headspace above the predetermined single dose volume of the liquid pharmaceutical; and sealing the filled recommended pharmaceutical vial with the recommended vial cap with seal to maintain the predetermined push pressure within the filled recommended pharmaceutical vial. In addition to the foregoing, other method aspects are described in the claims, drawings, and text forming a part of the present disclosure.

In an aspect, a method of filling a pharmaceutical vial includes, but is not limited to, accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal; filling the recommended pharmaceutical vial with the predetermined single dose volume of the liquid pharmaceutical; affixing the recommended vial cap to the filled recommended pharmaceutical vial with the seal; injecting the predetermined molar amount of the inert gas through a needle-penetrable portion of the affixed vial cap and into a volume of headspace above the predetermined single dose volume of the liquid pharmaceutical; and sealing the needle-penetrable portion of the affixed recommended vial cap to maintain the predetermined push pressure within the filled recommended pharmaceutical vial. In addition to the foregoing, other method aspects are described in the claims, drawings, and text forming a part of the present disclosure.

In an aspect, a pharmaceutical vial filled for use with a syringe includes, but is not limited to, a single dose volume of a liquid pharmaceutical, a cap including a needle-penetrable portion; a volume of headspace above the single dose volume of the liquid pharmaceutical and below the cap; a molar amount of an inert gas in the volume of headspace, the molar amount of inert gas proportional to a push pressure for the pharmaceutical vial and the syringe; and a seal fitted over a portion of the cap to secure the cap to the pharmaceutical vial and to maintain the push pressure in the volume of headspace. In addition to the foregoing, other device aspects are described in the claims, drawings, and text forming a part of the present disclosure.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a pharmaceutical vial filled for a syringe.

FIG. 2 is a schematic of a cross-section of a pharmaceutical vial filled for a syringe.

FIG. 3 is a schematic of a pharmaceutical vial filled for a syringe and a syringe.

FIG. 4 is a flowchart of a method of calculating a push pressure of a pharmaceutical vial with a syringe.

FIG. 5 is a flowchart showing aspects of a method such as depicted in FIG. 4.

FIG. 6 is a flowchart depicting aspects of a method such as illustrated in FIG. 4.

FIG. 7 is a graphic representation of volume of headspace versus pressure.

FIG. 8 is a graphic representation of static and dynamic force of a syringe.

FIG. 9 is a flowchart illustrating aspects of a method such as shown in FIG. 4.

FIG. 10 is a flowchart of a method of filling a pharmaceutical vial.

FIG. 11A is a schematic illustrating an aspect of a method such as shown in FIG. 10.

FIG. 11B is a schematic illustrating an aspect of a method such as shown in FIG. 10.

FIG. 11C is a schematic illustrating an aspect of a method such as shown in FIG. 10.

FIG. 11D is a schematic illustrating an aspect of a method such as shown in FIG. 10.

FIG. 12 is a flowchart of a method of filling a pharmaceutical vial.

FIG. 13A is a schematic illustrating an aspect of a method such as shown in FIG. 12.

FIG. 13B is a schematic illustrating an aspect of a method such as shown in FIG. 12.

FIG. 13C is a schematic illustrating an aspect of a method such as shown in FIG. 12.

FIG. 13D is a schematic illustrating an aspect of a method such as shown in FIG. 12.

FIG. 14 is a schematic of a system including circuitry.

FIG. 15 is a schematic of a system including circuitry.

FIG. 16 is a table with calculated motive pressure for different syringes with varied static force.

FIG. 17 is a table with calculated grams of inert gas for different push pressures.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Described herein are methods and devices for filling a pharmaceutical vial with a single dose volume of a liquid pharmaceutical and an inert gas to generate a push pressure for assessing the integrity of a sealed pharmaceutical vial. Further described herein are methods and devices for filling a pharmaceutical vial with a single dose volume of a liquid pharmaceutical and an inert gas to generate a push pressure for autofilling a syringe with the liquid pharmaceutical from a sealed pharmaceutical vial.

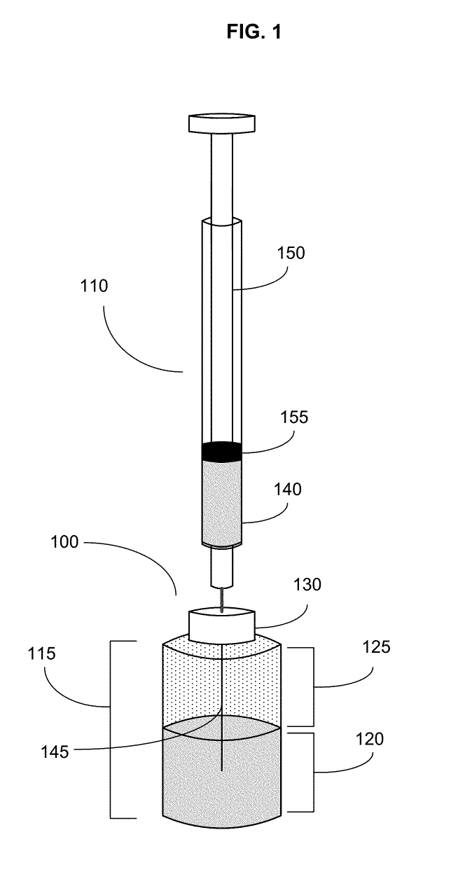

With reference to FIG. 1, shown is an example of a pharmaceutical vial filled for use with a syringe which can serve as a context for one or more devices, systems, and/or methods described herein. FIG. 1 includes pharmaceutical vial 100 for use in storing a liquid pharmaceutical and syringe 110 for use in injecting the liquid pharmaceutical into a subject. In the schematic of FIG. 1, syringe 110 is shown in the process of removing a liquid pharmaceutical from pharmaceutical vial 100. Pharmaceutical vial 100 includes an internal volume 115 including a single dose volume of liquid pharmaceutical 120 and volume of headspace 125. Volume of headspace 125 includes an inert gas sealed in pharmaceutical vial 100 by vial cap with seal 130. The molar amount of inert gas in volume of headspace 125 creates a push pressure within pharmaceutical vial 100. The push pressure is greater than atmospheric pressure and is defined as the greater of an ejection pressure or a static pressure. The ejection pressure is defined herein as a pressure needed to eject the entirety of single dose volume of liquid pharmaceutical 120 from pharmaceutical vial 100 into barrel 140 of syringe 110 through a flow path created by the insertion of needle 145 of syringe 110 through a needle-penetrable portion of vial cap with seal 130. The static pressure is defined herein as a pressure needed to initiate movement of plunger 150 of syringe 110. In an aspect, the static pressure is proportional to a static force required to initiate movement of plunger 150 and a cross-sectional area of the plunger, i.e., the cross-sectional area of gasket 155.

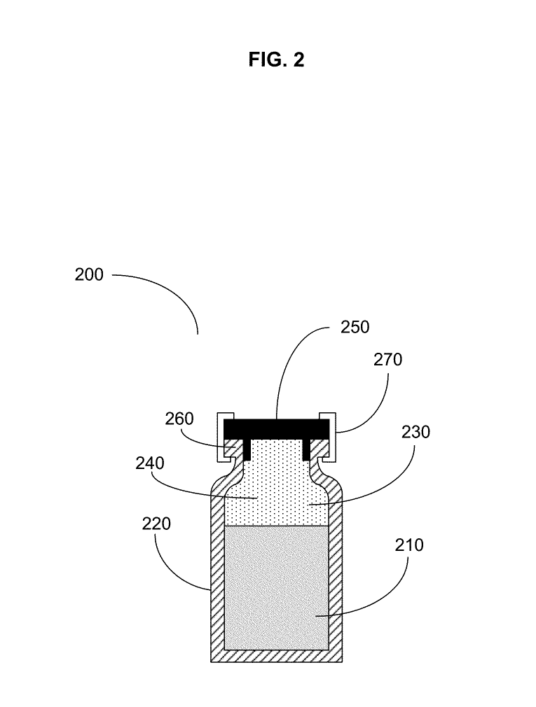

FIG. 2 is a schematic of a pharmaceutical vial filled for use with a syringe. Pharmaceutical vial 200 includes walls 220 forming a pharmaceutical storage region that includes single dose volume of a liquid pharmaceutical 210 and a molar amount of inert gas 230 included in a volume of headspace 240 over single dose volume of a liquid pharmaceutical 210. Volume of headspace 240 includes a sufficient molar amount of inert gas 230 to create a push pressure within pharmaceutical vial 200. Pharmaceutical vial 200 further includes vial cap 250 inserted into neck region 260 in an opening defined by walls 220 of pharmaceutical vial 200. Vial cap 250 is held in place with seal 270 and is configured to maintain the push pressure within pharmaceutical vial 200.

In an aspect, pharmaceutical vial 200 is a small container for parenteral liquid pharmaceuticals and is of generally conventional shape, having a generally cylindrical body, including a base, side walls, and a neck having an opening defined by a slightly thickened (relative to the side walls) annular rim or head portion. In an aspect, pharmaceutical vial 200 includes a limited volume insert (LVI) vial including a large opening with a cone-shaped insert for small liquid volumes. In an aspect, pharmaceutical vial 200 includes a crimp top vial for use with aluminum seals. In an aspect, pharmaceutical vial 200 includes a snap-top vial for use with snap ring seals. In an aspect, pharmaceutical vial 200 includes threads for use with a screw-top including a needle-penetrable septum.

In an aspect, pharmaceutical vial 200 is constructed from materials that adequately protect the liquid pharmaceutical from the environment, e.g., from light, loss of solvent, exposure to reactive gases (e.g., oxygen), absorption of water vapor, and microbial contamination. For example, the pharmaceutical vial may be constructed of an amber-colored or opaque material that protects the liquid pharmaceutical from light. For example, the pharmaceutical vial may be constructed of a non-permeable material, e.g., glass. In an aspect, pharmaceutical vial 200 is constructed from materials that are compatible and safe for use with the liquid pharmaceutical. In an aspect, pharmaceutical vial 200 is constructed of materials that are un-reactive, e.g., materials that do not absorb or adsorb components of the liquid pharmaceutical, do not leach impurities into the liquid pharmaceutical, and/or do not cause precipitation of or pH changes to the liquid pharmaceutical. For example, the pharmaceutical vial maybe constructed of a relatively un-reactive material, e.g., glass.

In an aspect, the pharmaceutical vials may be glass or glass-like vials or other suitably sterile and transparent vials that are available from commercial suppliers, e.g., from Wheaton Industries, Inc., Millville, N.J.; West Pharmaceutical Services, Inc., Exton, Pa. In an aspect, the pharmaceutical vial is manufactured from USP Type 1 borosilicate glass as defined by the United States Pharmacopeia (see, e.g., United States Pharmacopeia—National Formulary, Chapter <660>, Containers—Glass, which is incorporated herein by reference) and compliant with European, Japanese, and/or United States pharmacopeias.

In an aspect, the pharmaceutical vial is manufactured from a clear resin, e.g., a break-resistant cyclic olefin polymer. See, e.g., U.S. Patent Application 2008/0110852 to Kuroda & Ikeda titled “Medical Containers and Treating Method for Producing Medical Containers,” which is incorporated herein by reference. For example, pharmaceutical vials manufactured from Daikyo Crystal Zenith resin are available from commercial sources, e.g., from West Pharmaceutical Services, Inc., Exton, Pa.

In an aspect, the pharmaceutical vial further includes an internal surface property. For example, the pharmaceutical vial may include an internal coating that further protects the liquid pharmaceutical from any impurities in the walls of the pharmaceutical vial. For example, the pharmaceutical vial may include an internal coating that is hydrophobic to facilitate complete removal of the liquid pharmaceutical from the pharmaceutical vial. Pharmaceutical grade vials with internal coatings are available from commercial sources (from, e.g., SCHOTT North America, Inc., Lebanon, Pa.).

In an aspect, the pharmaceutical vial is characterized by one or more parameters. In an aspect, the one or more parameters include at least one of an internal volume of the pharmaceutical vial, a maximum pressure capacity of the pharmaceutical vial, an internal surface property, and/or a vial identification code. Other parameters may include dimensions of the walls, e.g., thickness, or dimensions of the neck, e.g., inner diameter. In an aspect, the one or more parameters are used to determine a recommended pharmaceutical vial, e.g., of appropriate internal volume and pressure capacity, for a given single dose volume of a liquid pharmaceutical.

Pharmaceutical vial 200 includes single dose volume of a liquid pharmaceutical 210. In an aspect, the single dose volume can be referred to in terms of milliliters (ml) or cubic centimeters (cc). In an aspect, the single dose volume of the liquid pharmaceutical is configured for intramuscular, subcutaneous, or intradermal injection. In an aspect, the single dose volume of liquid pharmaceutical is configured for oral, nasal, urethral, anal, or vaginal administration. In an aspect, the single dose volume of liquid pharmaceutical is configured for intraocular injection. In an aspect, the single dose volume of the liquid pharmaceutical is dependent upon the type of liquid pharmaceutical. In an aspect, the single dose volume of the liquid pharmaceutical is a clinically-determined effective or therapeutic dose for that type of liquid pharmaceutical. For example, recommended doses for common vaccines range from 0.05 ml for BCG (tuberculosis) vaccine to 1.0 ml for Hepatitis A vaccine. In an aspect, the single dose volume of the liquid pharmaceutical is dependent upon the site of injection, e.g., intramuscular, subcutaneous, or intradermal. For example, a single dose volume of an intramuscular injection of a liquid pharmaceutical may be as great as 5 ml. See, e.g., Hopkins & Arias (2013) “Large volume IM injections: A review of best practices,” Oncology Nurse Advisor January/February, which is incorporated herein by reference. In an aspect, the single dose volume of the liquid pharmaceutical is dependent upon the size of the individual who will be receiving the liquid pharmaceutical. For example, the single dose volume may be dependent upon the size, e.g., weight, of the intended recipient, e.g., a child versus an adult. For example, a single dose volume for a subcutaneous injection of a liquid pharmaceutical may be 0.5 ml, 1 ml, or 2 ml depending upon the size of the child or adult. In an aspect, the single dose volume of the liquid pharmaceutical ranges from about 0.01 ml to about 5 ml. For example, in some embodiments, the single dose volume of the liquid pharmaceutical can be 0.01 ml, 0.02 ml, 0.05 ml, 0.075 ml, 0.1 ml, 0.15 ml, 0.2 ml, 0.25 ml, 0.3 ml, 0.35 ml, 0.4 ml, 0.45 ml, 0.5 ml, 0.55 ml, 0.6 ml, 0.65 ml, 0.7 ml, 0.75 ml, 0.8 ml, 0.85 ml, 0.9 ml, 1.0 ml, 1.25 ml, 1.5 ml, 1.75 ml, 2.0 ml, 2.25 ml, 2.5 ml, 2.75 ml, 3.0 ml, 3.25 ml, 3.5 ml, 3.75 ml, 4.0 ml, 4.25 ml, 4.5 ml, 4.75 ml, or 5.0 ml.

In an aspect, the single dose volume of the liquid pharmaceutical is less than or equal to a preset percentage of an internal volume of the pharmaceutical vial. In general, the greater the single dose volume of the liquid pharmaceutical relative to the internal volume of the pharmaceutical vial, the greater the push pressure required to eject the entirety of the liquid pharmaceutical out of the pharmaceutical vial. In an aspect, the preset percentage of the internal volume of the pharmaceutical vial ranges from about 10% to about 90%. For example, the preset percentage of the internal volume can be 10%, 15%, 20%, 25%, 30%, 35%, 40%, 45%, 50%, 55%, 60%, 65%, 70%, 75%, 80%, 85%, or 90%. In an aspect, the preset percentage of the internal volume of the pharmaceutical vial is no greater than 80%.

In an aspect, the liquid pharmaceutical includes at least one vaccine configured for immunization against one or more infectious agent, disease, or condition, non-limiting examples of which include anthrax, tuberculosis (BCG), cholera, Dengue fever, diphtheria, tetanus, pertussis, haemorrhagic fever, haemophilus b (Hib), hepatitis A, hepatitis B, human papillomavirus, influenza, Japanese encephalitis, malaria, measles, meningococcal meningitis, mumps, poliovirus, rubella, varicella virus, plague, Pneumococcus, rabies, Rift Valley fever, rotavirus, rubella, smallpox, rotovis typhoid yellow fever, and shingles. In an aspect, the liquid pharmaceutical includes two or more vaccines. For example, the liquid pharmaceutical can include the DPT vaccine including vaccines against diphtheria, tetanus, and pertussis.

In an aspect, the liquid pharmaceutical includes at least one therapeutic agent, non-limiting examples of which include antibiotics, e.g., penicillin, cefuroxime, ceftazidime; interferons, e.g., interferon alpha, beta, or gamma; peripheral vasodilators, e.g., alprostadil; anticoagulants, e.g., fondapainux; gonadotrophins, e.g., follitropin; anabolic hormones, e.g., somatropin; bone formation agents, e.g., teriparatide; HIV drugs, e.g., enfuvirtide; contraceptives, e.g., medroxyprogesterone acetate; anti-inflammatory agents, e.g., etanercept, adalimumab; serotonin receptor antagonists, e.g., sumatriptan; GRH analogs, e.g., leuprolide; chemotherapies, insulin, hormones, anti-infectives, and the like.

In an aspect, the liquid pharmaceutical includes an active ingredient. In an aspect, the active ingredient includes one or more vaccines. In an aspect, the active ingredient includes one or more therapeutic agents. In some embodiments, the liquid pharmaceutical includes additional inactive ingredients, e.g., excipients, configured to preserve, stabilize, or otherwise protect the active ingredient in the liquid pharmaceutical. Non-limiting examples of inactive ingredients or excipients include solvents or co-solvents, e.g., water or propylene glycol, buffers, anti-microbial preservatives, anti-oxidants, or wetting agents, e.g., polysorbates or poloxamers.

Pharmaceutical vial 200 includes a volume of headspace 240 over single dose volume of liquid pharmaceutical 210. In some embodiments, a volume of headspace 240 is defined as a volume of sealed space between the surface of single dose volume of liquid pharmaceutical 210 in pharmaceutical vial 200, at least a portion of walls 220, and the surface of vial cap 250 protruding into the interior portion of pharmaceutical vial 200. In some embodiments, the volume of headspace is defined as a volume of space between the exposed surface of the single dose volume of liquid pharmaceutical in the pharmaceutical vial, the side walls of the pharmaceutical wall, and the opening of the pharmaceutical vial.

In an aspect, the higher the volume of headspace relative to the single dose volume of the liquid pharmaceutical, the lower the push pressure required to move the entirety of the liquid pharmaceutical out of the pharmaceutical vial. Conversely, in an aspect with a lower volume of headspace relative to the single dose volume of the liquid pharmaceutical, the higher the push pressure required to move the entirety of the liquid pharmaceutical out of the pharmaceutical vial. In an aspect, the volume of headspace comprises at least 20% of the internal volume of the pharmaceutical vial.

Volume of headspace 240 includes a molar amount of inert gas 230. In an aspect, the molar amount of inert gas 230 is proportional to the single dose volume of liquid pharmaceutical 210 and volume of headspace 240. For example, the molar amount of inert gas is calculated to be sufficient to push the entirety of the single dose volume of liquid pharmaceutical out of the pharmaceutical vial. In an aspect, the inert gas is a gas that does not undergo chemical interactions with components of the liquid pharmaceutical and/or the internal surfaces of the pharmaceutical vial and/or vial cap. In an aspect, the molar amount of inert gas includes a molar amount of nitrogen. In an aspect, the molar amount of inert gas includes a molar amount of argon. In an aspect, the molar amount of inert gas includes a molar amount of helium. In an aspect, the molar amount of inert gas includes other noble bases, e.g., neon, krypton, and xenon. In an aspect, the molar amount of inert gas includes carbon dioxide. In an aspect, atmospheric air is purged from the volume of headspace prior to adding the inert gas to the volume of headspace.

Pharmaceutical vial 200 further includes vial cap 250. Vial cap 250 is inserted into neck region 260 in an opening defined by walls 220 of pharmaceutical vial 200. In an aspect, the vial cap is configured to fit snuggly in the opening in the neck region of the pharmaceutical vial. In an aspect, the portion of the vial cap inserted into the opening of the neck of pharmaceutical vial is potentially in contact with the liquid pharmaceutical. In an aspect, at least the portion of the vial cap potentially in contact with the liquid pharmaceutical is constructed of materials, e.g., elastomeric materials, which will not interact with the components of the liquid pharmaceutical.

In an aspect, the vial cap includes a stopper, e.g., a stopper. For example, the stopper may be one of a number of commonly available type of stopper comprised of rubber or other suitable material. In an aspect, the stopper includes a generally disc shape and has a portion that extends into the opening defined by the neck of the pharmaceutical vial. Non-limiting examples of stoppers for use with pharmaceutical vials include straight plug, sleeve, snap-on, igloo, lyophilization, and thin flange lyophilization. In an aspect, the vial cap may be a stopper made of a non-reactive elastomeric material. For example, the vial cap may be a stopper constructed of a type of butyl rubber as described in U.S. Pat. No. 7,282,269 to Wang & Wong titled “Cured Rubber Components for use with Pharmaceutical Device,” which is incorporated herein by reference. Non-limiting examples of non-reactive elastomeric materials for a stopper include rubber, butyl rubber, bromobutyl rubber, ethylene propylene diene monomer (EPDM) rubber, fluorocarbon elastomers, polytetrafluoroethylene (PTFE), chlorobutylisoprene, or combinations thereof. For example, the vial cap can include a bromobutyl formulated rubber stopper that complies with the European, United States, and Japanese Pharmacopeias and is available from commercial sources, e.g., from Wheaton Industries, Inc., Millville, N.J. In an aspect, the rubber stopper includes a coating to prevent interaction of the rubber with the liquid contents of the pharmaceutical vial. For example, the rubber stopper may be at least partially coated with a fluorinated resin, e.g., PTFE, as described in U.S. Pat. No. 5,484,566 to Gaggard titled “Method of manufacture of a partially laminated rubber closure,” which is incorporated herein by reference. In an aspect, the vial cap includes a needle-penetrable portion configured to allow passage of an injection needle through the vial cap and into the interior portion of the pharmaceutical vial.

In an aspect, the vial cap includes a septum for use with a screw cap. Non-limiting examples of septa material include red rubber, silicone, polytetrafluoroethylene (PFTE), e.g., Teflon, fluoroelastomer, e.g., Viton®, or combinations thereof. Septa for use with screw-type vial caps are available from commercial sources, e.g., from Sigma-Aldrich, St. Louis, Mo.

In an aspect, vial cap 250 is manufactured from a material capable of being resealed after being penetrated by a needle. See, e.g., U.S. Pat. No. 6,684,916 to Py titled “Medicament vial having a heat-sealable cap, and apparatus and method for filling the vial,” which is incorporated herein by reference. For example, the liquid pharmaceutical and/or the molar amount of inert gas may be injected into the pharmaceutical vial through a sealable vial cap using a needle or other injection member. For example, the vial cap may include a vulcanized rubber or other material that is treatable with a laser or directed heat source to seal an area of the vial cap punctured with the needle or other injection member following injection of the liquid pharmaceutical and/or the inert gas. For example, the vial cap may be constructed of a blend of polymeric materials from Kraton Performance Polymers, Inc., Belpre, Ohio, under the registered trademark KRATON® or from Dow Chemical Co, Midland, Mich., under the trademarks ENGAGE™ or EXACT™.

Vial cap 250 is held in place with seal 270 and is configured to maintain the push pressure within pharmaceutical vial 200. In an aspect, vial cap 250 is affixed over the opening of pharmaceutical vial 200 with a seal 270. For example, a seal can be used to secure a vial cap, e.g., a rubber stopper, to the pharmaceutical vial in order to maintain the integrity of the seal under normal conditions of transport, handling and storage during the intended shelf-life of the product. In an aspect, the seal is constructed of aluminum and is attached to the vial cap and pharmaceutical vial by crimping the aluminum at least partially over the vial cap and around the neck of the pharmaceutical vial. In an aspect, the seal is a screw cap that screws onto the neck portion of the pharmaceutical vial, holding the vial cap in place. In an aspect, the vial cap with seal includes a closure assembly and locking cap as described in U.S. Patent Application 2012/0248057 to Bogle & Asselta titled “Cap Systems and Methods for Sealing Pharmaceutical Vials,” which is incorporated herein by reference.

In an aspect, the pharmaceutical vial includes a septa and aluminum seal that can withstand positive pressures. For example, the pharmaceutical vial can include a type of commercially available pressure release seal designed to open at greater than 3 bar or approximately 45 psi (from, e.g., Wheaton Industries, Inc., Millville, N.J.).

In an aspect, the pharmaceutical vial further includes a removable lid sized to fit securely over at least a portion of the vial cap. In an aspect, the removable lid includes a security seal. For example, the pharmaceutical vial can include a commercially available foil security seal that self-destructs upon attempted removal (from, e.g., Cardinal Health, Dublin, Ohio). For example, the pharmaceutical vial can include an aluminum crimping seal that further includes a removable top flap. In an aspect, the security seal can include a plastic top which when removed cannot be repositioned.

In an aspect, vial cap 250 and seal 270 are configured to maintain a push pressure within the pharmaceutical vial. In an aspect, the molar amount of inert gas in the volume of headspace above the liquid pharmaceutical creates the push pressure in the sealed pharmaceutical vial. In an aspect, the push pressure comprises a pressure greater than atmospheric pressure outside the pharmaceutical vial. In an aspect, the push pressure includes a pressure equal to an ejection pressure sufficient to eject the single dose volume of the liquid pharmaceutical into a syringe. In an aspect, the push pressure includes a pressure equal to a motive pressure sufficient to move a plunger of a syringe. In an aspect, the push pressure includes the greater of an ejection pressure sufficient to eject the single dose volume of the liquid pharmaceutical into the syringe or a motive pressure sufficient to move a plunger associated with the syringe.

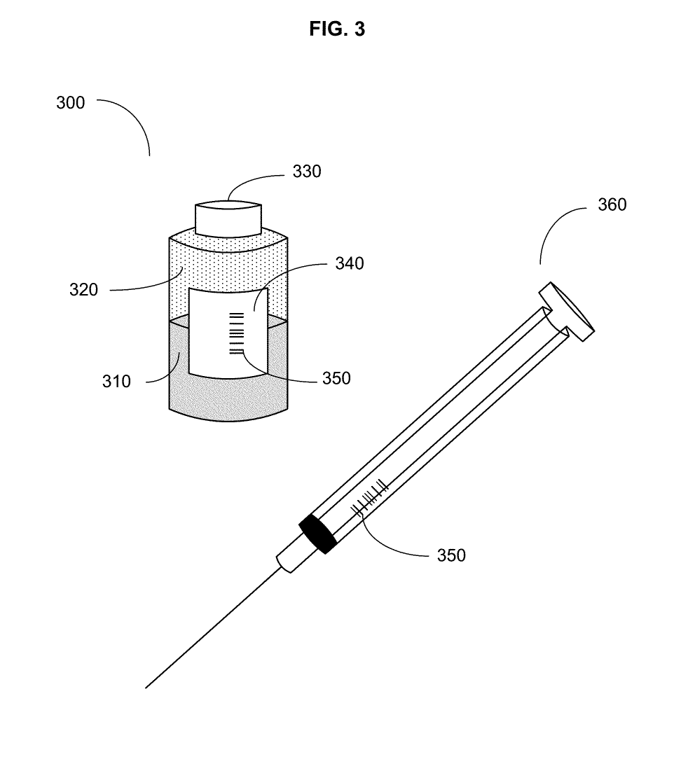

FIG. 3 illustrates further aspects of a pharmaceutical vial filled for use with a syringe including a label. Shown in FIG. 3 is a schematic of pharmaceutical vial 300 and syringe 360. Pharmaceutical vial 300 includes single dose volume of liquid pharmaceutical 310 and a molar amount of inert gas in volume of headspace 320. A push pressure created by the molar amount of inert gas is maintained with vial cap and seal 330. Pharmaceutical vial 300 includes label 340. In an aspect, label 340 includes a recommended syringe type for use with pharmaceutical vial 300. In an aspect, label 340 includes a vial code to match a syringe code. In an aspect, the vial code to match the syringe code includes at least one or a color code, a bar code, or an RFID tag. For example, as shown in FIG. 3, pharmaceutical vial 300 includes bar code 350 that matches bar code 350 on syringe 360. In an aspect, label 340 further includes standard labeling information including, but not limited to, the name of the liquid pharmaceutical, active and inactive ingredients, dosing information, the expiration date, the manufacturer, the batch number, and the like.

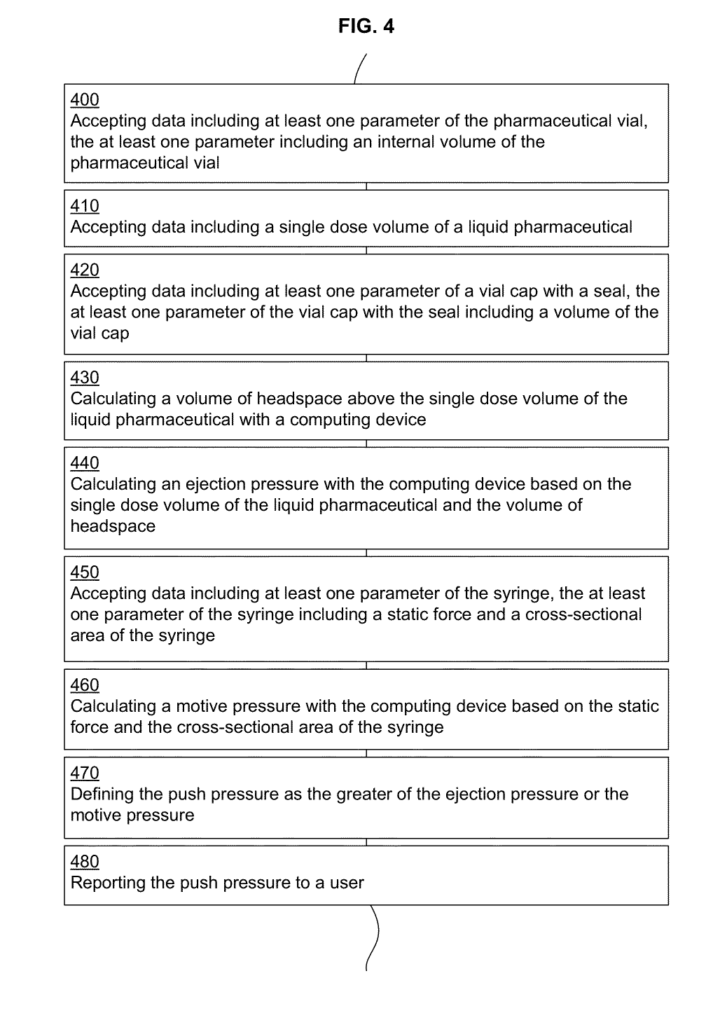

FIG. 4 illustrates aspects of a method for calculating a push pressure for a pharmaceutical vial with a syringe. The method includes in block 400, accepting data including at least one parameter of the pharmaceutical vial, the at least one parameter of the pharmaceutical vial including an internal volume of the pharmaceutical vial; in block 410, accepting data including a single dose volume of a liquid pharmaceutical; in block 420, accepting data including at least one parameter of a vial cap with a seal, the at least one parameter of the vial cap with the seal including a volume of the vial cap; in block 430, calculating a volume of a headspace over the single dose volume of the liquid pharmaceutical with a computing device; in block 440, calculating an ejection pressure with the computing device based on the single dose volume of the liquid pharmaceutical and the volume of headspace; in block 450, accepting data including at least one parameter of the syringe, the at least one parameter of the syringe including a static force and a cross-sectional area of the syringe; in block 460, calculating a motive pressure with the computing device based on the static force and the cross-sectional area of the syringe; in block 470, defining the push pressure as the greater of the ejection pressure or the motive pressure; and in block 480, reporting the push pressure to a user.

In an aspect, the method includes calculating a push pressure for a pharmaceutical vial type with a syringe type, the push pressure defined herein as the greater of an ejection pressure sufficient to eject a single dose volume of liquid pharmaceutical from the pharmaceutical vial and into the syringe, or a motive pressure sufficient to move a plunger associated with the syringe. In an aspect, the method includes calculating a push pressure for a specific pharmaceutical vial type for use with a specific syringe type. In an aspect, the method includes calculating a push pressure for a specific pharmaceutical vial model for use with a specific syringe model.

In an aspect, the method described herein for calculating a push pressure for a pharmaceutical vial with a syringe is implemented with a computing device. In an aspect, the computing device may include all of the information or instructions needed to implement the steps of the method. For example, the information or instructions for implementing the steps of the method may be included in circuitry configured for use with the computing device. For example, the information or instructions for implementing the steps of the method may include algorithms configured for use with the computing device. For example, the information or instructions for implementing the steps of the method may be included in software configured to run on the computing device. In an aspect, the computing device is operably coupled to a user interface allowing for entry of data into the computing device by a user, e.g., a vialing technician. In an aspect, the computing device is operably coupled to a vialing apparatus.

In an aspect, the method includes accepting data including at least one parameter of a pharmaceutical vial. In an aspect, the method includes accepting data including an internal volume of the pharmaceutical vial. In an aspect, the method includes accepting data including a maximum pressure capacity, a vial identification code, or an internal surface property. In an aspect, the method includes accepting data including at least one parameter of the pharmaceutical vial from a look-up table. In an aspect, the look-up table includes an array including a list of specific pharmaceutical vials and associated parameters. For example, the look-up table including at least one property of an assortment of pharmaceutical vial types can be provided by a manufacturer of pharmaceutical vials. For example, the look-up table including at least one property of an assortment of pharmaceutical vial types can be incorporated into a memory component of the computing device. In an aspect, the method includes accepting data including at least one parameter of the pharmaceutical vial from a linked list. In an aspect, the method includes accepting data including at least one parameter of the pharmaceutical vial from a user input. For example, the method can include having a user enter the data including the at least one parameter, e.g., the internal volume, into the computing device using a user interface, e.g., a keyboard and display. In an aspect, the method includes accepting the data from a remote source through the Internet or other web-based connection.

In an aspect, the method includes accepting data including a single dose volume of a liquid pharmaceutical. In an aspect, the method includes accepting data including a single dose volume of a liquid pharmaceutical in terms of milliliters (ml) or cubic centimeters (cc). In an aspect, the method includes accepting data including a single dose volume of a liquid pharmaceutical configured for intramuscular, subcutaneous, or intradermal injection. In an aspect, the method includes accepting data including a single dose volume of at least one vaccine. In an aspect, the method includes accepting data including a single dose volume of at least one therapeutic agent. In an aspect, the method includes accepting data including a single dose volume of a liquid pharmaceutical that is a clinically determined effective or therapeutic dose for that type of liquid pharmaceutical. In an aspect, the method includes accepting data including a single dose volume of a liquid pharmaceutical that is sized appropriately for the site of injection, e.g., intramuscular, subcutaneous, or intradermal. In an aspect, the method includes accepting data including a single dose volume of a liquid pharmaceutical that is sized appropriately for the size of the individual who will be receiving the liquid pharmaceutical, e.g., a child versus an adult. In an aspect, the method includes accepting data including a single dose volume of a liquid pharmaceutical that ranges from about 0.01 ml to about 5 ml. For example, in some embodiments, the single dose volume of the liquid pharmaceutical can be 0.01 ml, 0.02 ml, 0.05 ml, 0.075 ml, 0.1 ml, 0.15 ml, 0.2 ml, 0.25 ml, 0.3 ml, 0.35 ml, 0.4 ml, 0.45 ml, 0.5 ml, 0.55 ml, 0.6 ml, 0.65 ml, 0.7 ml, 0.75 ml, 0.8 ml, 0.85 ml, 0.9 ml, 1.0 ml, 1.25 ml, 1.5 ml, 1.75 ml, 2.0 ml, 2.25 ml, 2.5 ml, 2.75 ml, 3.0 ml, 3.25 ml, 3.5 ml, 3.75 ml, 4.0 ml, 4.25 ml, 4.5 ml, 4.75 ml, or 5.0 ml.

In an aspect, the method includes accepting the data including the single dose volume of the liquid pharmaceutical from a look-up table. For example, the computing device may include a look-up table that includes a list of liquid pharmaceuticals and appropriate single dose volumes for a given patient population and/or disease or condition. For example, the computing device may include a look-up table that includes a list of liquid pharmaceuticals and appropriate single dose volumes for a given injection site, e.g., intramuscular versus subcutaneous. In an aspect, the method includes accepting the data including the single dose volume of the liquid pharmaceutical from a user input. For example, a user, e.g., a vialing technician, may enter the appropriate single dose volume for a specific liquid pharmaceutical into a computing device using a user interface, e.g., a keyboard or touchpad and a display. In an aspect, the method includes accepting data from a remote source, e.g., a manufacturer, over the Internet or through another web-based connection.

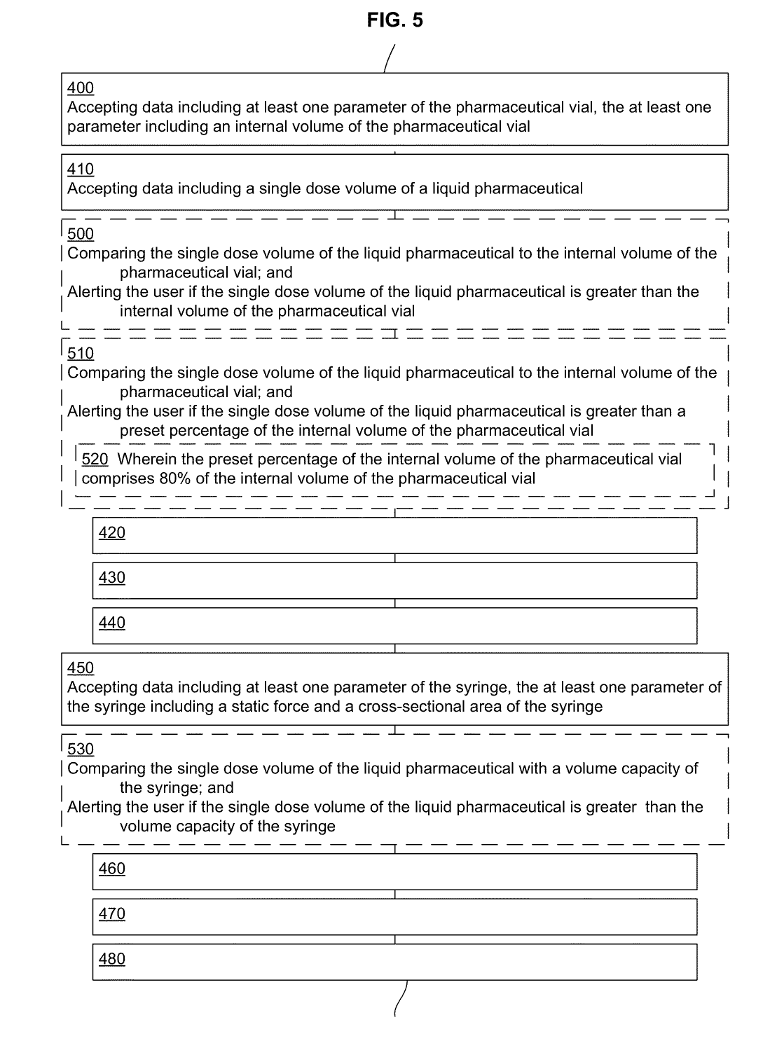

FIG. 5 shows further aspects of a method such as shown in FIG. 4. The method includes accepting data including an internal volume of the pharmaceutical vial (in block 410) and accepting data including a single dose volume of a liquid pharmaceutical (in block 420). In an aspect, the method further includes comparing the single dose volume of the liquid pharmaceutical to the internal volume of the pharmaceutical vial, as shown in block 500, and alerting the user if the single dose volume of the liquid pharmaceutical is greater than the internal volume of the pharmaceutical vial. In an aspect, the method includes comparing the single dose volume of the liquid pharmaceutical to the internal volume of the pharmaceutical vial and that portion of the volume of the vial cap that is inserted into to the pharmaceutical vial, and alerting the user if the single dose volume of the liquid pharmaceutical is greater than the internal volume of the pharmaceutical vial and that portion of the volume of the vial cap that is inserted into the pharmaceutical vial. For example, a selected vial may have an internal volume sufficient for the single dose volume of the liquid pharmaceutical but not sufficient if the portion of the volume of the vial cap that is inserted into the pharmaceutical vial is included in the calculation.

In an aspect, the method further includes comparing the single dose volume of the liquid pharmaceutical to the internal volume of the pharmaceutical vial, as shown in block 510, and alerting the user if the single dose volume of the liquid pharmaceutical is greater than a preset percentage of the internal volume of the pharmaceutical vial. In general, the greater the volume of the liquid pharmaceutical relative to the internal volume of the pharmaceutical vial, the greater the push pressure required to eject the entirety of the liquid pharmaceutical out of the pharmaceutical vial. In an aspect, the preset percentage of the internal volume of the pharmaceutical vial ranges from about 10% to about 90%. For example, the preset percentage of the internal volume can be 10%, 15%, 20%, 25%, 30%, 35%, 40%, 45%, 50%, 55%, 60%, 65%, 70%, 75%, 80%, 85%, or 90%. In an aspect, the preset percentage of the internal volume of the pharmaceutical vial is no greater than 80%, as shown in block 520.

In an aspect, the method includes accepting data including at least one parameter of a vial cap with a seal. In an aspect, method includes accepting data including a volume of the vial cap with the seal. In an aspect, the method includes accepting data including a vial identification code or a maximum pressure capacity of the vial cap with a seal. In an aspect, the method includes accepting the data including at least one parameter of a vial cap with a seal from a look-up table. For example, the method can include accepting data from a look-up table incorporated into the computing device. In an aspect, the method includes accepting data including at least one parameter of a vial cap with a seal from a user input. For example, the at least one parameter of the vial cap with the seal can be entered into a computing device using a user input, e.g., a keyboard or touchpad with a display. For example, the at least one parameter of the vial cap with the seal can be accepted by the computing device from a remote source, e.g., a manufacturer, through the Internet or other web-based connection.

In an aspect, the method includes calculating a volume of headspace over the liquid pharmaceutical vial using a computing device. In an aspect, the volume of headspace is calculated based on subtracting from the internal volume of the pharmaceutical vial the single dose volume of the liquid pharmaceutical and a portion of the volume of the vial cap intended for positioning adjacent to the internal volume of the pharmaceutical vial. For example, a vial cap may include a volume of 2 centimeters cubed of which 25% is inserted into a pharmaceutical vial with a 2 centimeters cubed (2 milliliters) internal volume for holding a single dose volume of 1 centimeters cubed (1 milliliters) of liquid pharmaceutical. The volume of headspace is calculated to be 0.75 centimeters cubed. In an aspect, the volume of the vial cap with seal and/or the internal volume of the pharmaceutical vial is optically measured. See, e.g., U.S. Pat. No. 6,442,503 to Bengala titled “Process and Apparatus for Measuring the Volume of an Object.”

In an aspect, the method includes calculating an ejection pressure with the computing device. In an aspect, the ejection pressure includes a pressure required in the pharmaceutical vial under a sealed condition to eject the entirety of the single dose volume of the liquid pharmaceutical through a flow path created by the syringe. In an aspect, the ejection pressure includes a pressure within the pharmaceutical vial that is sufficient to transfer the entirety of the single dose volume of the liquid pharmaceutical from the pharmaceutical vial and into the barrel of a syringe when a needle associated with the syringe is inserted into the sealed pharmaceutical vial. In an aspect, the ejection pressure includes a pressure required in the pharmaceutical vial to enable autofilling of the syringe when a needle attached to the syringe is inserted into the sealed pharmaceutical vial through a needle-penetrable portion of the vial cap.

In an aspect, calculating the ejection pressure includes calculating a pressure/volume relationship. For a given molar amount of a gas at a fixed temperature, the pressure exerted by the gas is inversely proportional to the volume of the gas. In an aspect, the method includes determining the amount of gas needed to fill the vial based on Boyle's Law, which states that the volume of a definite quantity of dry gas is inversely proportional to the pressure, as long as the temperature remains constant and is represented by equation PV=k, where P is equal to pressure, V is equal to volume and k is a constant. In general, it is understood that for a given molar amount of gas at a given temperature, the following equation represents the pressure/volume relationship:

P₁×V₁=P₂×V₂

In an aspect, the entirety of the single dose volume of the liquid pharmaceutical is pushed out of the internal volume of the pharmaceutical volume by expanding the volume of a gas while reducing the pressure in response to introducing a flow path out of the vial, e.g., a flow path formed from an injection needle inserted into the sealed pharmaceutical vial. In an aspect, the ejection pressure (P_{Ejection}) is calculated as follows:

$${P}_{Ejection} = \frac{{V}_{Liquid}}{{V}_{Headspace}} + 1 bar$$

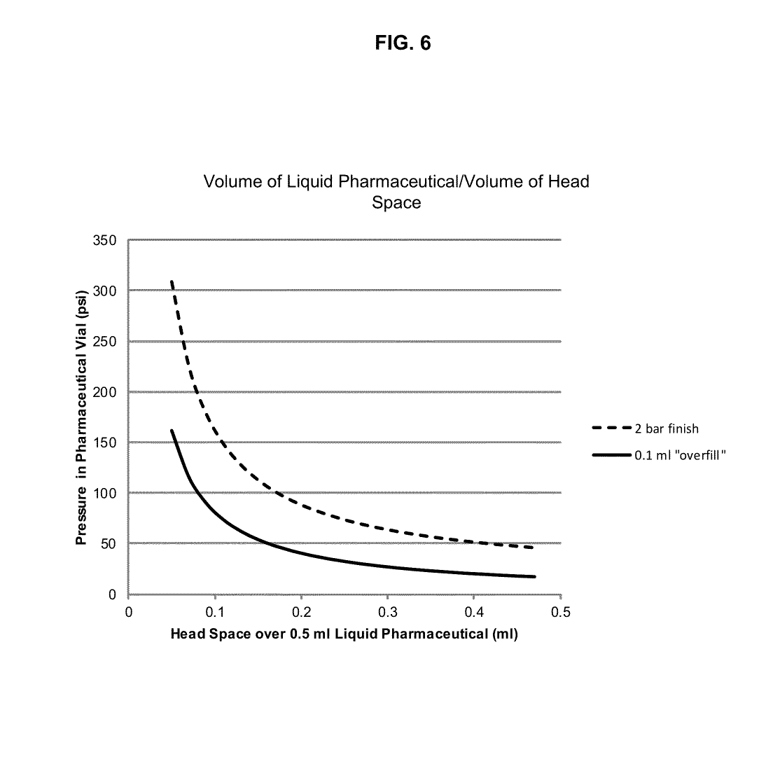

As the volume of liquid pharmaceutical increases and the volume of headspace decreases for a given internal volume of pharmaceutical vial, the pressure required to eject the volume of liquid pharmaceutical increases. An example of this relationship is illustrated in FIG. 6.

FIG. 6 graphically illustrates a relationship between the volume of headspace over a 0.5 ml single dose volume of a liquid pharmaceutical on the x-axis and the pressure in the pharmaceutical vial (in pounds per square inch, psi) on the y-axis. The solid line represents this relationship in which an additional 0.1 ml of inert gas is ejected from the vial. The dashed line represents this relationship in which the final pressure remaining in the vial after ejecting the single dose volume of liquid pharmaceutical is 1 bar or 14.7 psi over atmospheric pressure.

Returning to FIG. 4, the method further includes accepting data including at least one parameter of the syringe in block 450. In an aspect, the method includes accepting data including at least one parameter of a syringe type intended for use with a specific pharmaceutical vial type. In an aspect, the at least one parameter includes a static force and a cross-sectional area of the syringe. In an aspect, the at least one parameter includes at least one of a volume capacity. In an aspect, the at least one parameter includes a syringe identification code. In an aspect, the at least one syringe identification code is matched with a vial identification code. In an aspect, the syringe can include any of a number of standard syringes used for injection of vaccines and/or therapeutic agents available from commercial sources, e.g., from Becton, Dickinson and Company, Franklin Lakes, N.J. or Covidien, Mansfield, Mass. In an aspect, the syringe can include any of a variety of sizes including, but not limited to, 0.05 ml, 0.1 ml, 0.5 ml, 1.0 ml, 3 ml, 5 ml, 6 ml, 10 ml, 20 ml, 35 ml, 50 ml, or 60 ml. In an aspect, the syringe is manufactured from plastic. In an aspect, the syringe is manufactured from glass. In an aspect, the syringe is intended for single use. In an aspect, the syringe includes any of a number of standard syringes, auto-disable syringes, or retractable syringes pre-qualified for use by the World Health Organization. See, e.g., Product List at WHO website accessed Dec. 10, 2013 at the following address http://apps.who.int/immunization_standards/vaccine_quality/pqs_cataloque/categorypage.aspx?id_cat=37, which is incorporated herein by reference.

In an aspect, the method includes accepting data including a volume capacity of the syringe for use with the specific pharmaceutical vial type. As shown in block 530 of FIG. 5, the method can optionally include comparing the single dose volume of the liquid pharmaceutical with a volume capacity of the syringe; and alerting the user if the single dose volume of the liquid pharmaceutical is greater than the volume capacity of the syringe.

In an aspect, the method includes accepting data including a static force of a syringe type intended for use with a specific pharmaceutical vial type. The static force is defined herein as the force required to initiate movement of a plunger of the syringe. In general, a syringe plunger creates a tight seal inside the syringe, i.e., inside the barrel of the syringe, usually with the assistance of a small rubber or plastic gasket, preventing the contents of the syringe from escaping out the rear of the syringe. When the plunger is pulled back, a vacuum is created inside the barrel of the syringe, sucking up fluid or gases that the syringe is in contact with. Interaction between the small rubber or plastic gasket with the side-walls of the syringe barrel creates friction. A certain amount of static force is required to overcome static friction to initiate movement of the syringe plunger and a certain amount of dynamic force is required to overcome dynamic friction to maintain movement of the syringe plunger. In most instances, the static friction associated with a syringe plunger exceeds the dynamic friction associated with the syringe plunger.

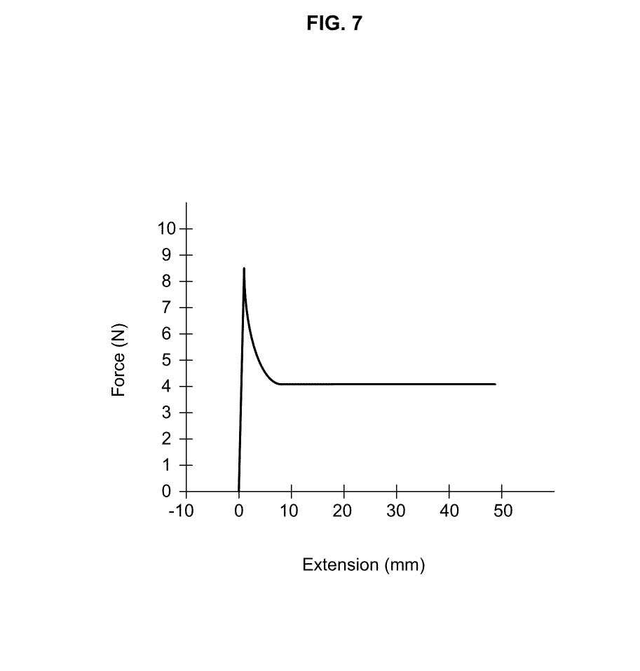

FIG. 7 illustrates a graphic example of the force required to initiate movement of a plunger and to maintain movement. In this example, extension, e.g., distance travelled, of the plunger (in millimetres) is on the x-axis and force (in Newtons) required to move the plunger is on the y-axis. In general, the force required to move the plunger of a syringe needle can be measured using a force transducer. See, e.g., Mac Murdo and Buffington “Brand and size matter when choosing a syringe to relieve pressure in a tracheal tube cuff,” Anesth. Analg. (2004) 99:1445-1449, which is incorporated herein by reference. In an aspect, a syringe testing machine such as available commercially from Instron, Norwood, Mass., can be used to determine the forces required to move the plunger.

In an aspect, the method includes accepting data including a cross-sectional area of a syringe type intended for use with a specific pharmaceutical vial type. In an aspect, the cross-sectional area of the syringe is defined as the cross-sectional area of the plunger of the syringe. In an aspect, the cross-sectional area of the syringe is dependent upon the size of the syringe. In an aspect, the cross-sectional area of any given syringe is obtained from the manufacturer of said syringe. In an aspect, the cross-sectional area of any given syringe can be calculated based on measurement of the internal diameter of the syringe and application of formulas for determining the area of a circle.

The method further includes calculating a motive pressure based on the static force and the cross-sectional area of the syringe. The motive pressure is defined herein as the amount of pressure within the sealed pharmaceutical vial required to initiate movement of the plunger of the syringe when a needle connected to the syringe is inserted into an interior portion of the pharmaceutical vial. For example, the motive pressure is the amount of pressure within the sealed pharmaceutical vial required to initiate movement of the plunger of the syringe when a needle connected to the syringe is inserted into the headspace of the pharmaceutical vial. In general, pressure is defined as force per unit area. In an aspect, to initiate movement of the plunger, the pressure exerted by the inert gas and/or single dose volume of liquid pharmaceutical coming out of the vial through the flow path formed by the inserted needle is equal to or greater than the static force of the syringe divided by the cross-sectional area of the syringe, or:

$${P}_{Motive} \geq \frac{{F}_{static force of syringe}}{{A}_{cross \text{-} sectional area of syringe}}$$

In an aspect, the motive pressure is calculated in pounds per square inch using the following equation:

$${P}_{Motive} ( psi ) = \frac{lb}{{in}^{2}} = {F}_{static force of syringe} ( N ) \times \frac{1 lb}{4.45 N} \times \frac{1}{{in}^{2}}$$

For example, if the static force required to initiate movement of the plunger of a syringe is 10 Newtons and the cross-sectional area of a standard 1 ml syringe is about 0.03 in², the pressure in psi to exert the 10 Newtons of force is about 75 psi or about 5 bar.

The method further includes defining the push pressure as the greater of the ejection pressure or the motive pressure. In an aspect, the push pressure is the least amount of positive pressure required to initiate movement of a plunger of syringe and to eject the entirety of the liquid pharmaceutical from the pharmaceutical vial and into the syringe. For example, the ejection pressure may be sufficient to eject the entirety of the liquid pharmaceutical but not sufficient to overcome the motive pressure required to initiate movement of the plunger. For example, the motive pressure may be sufficient to initiate movement of the plunger, but insufficient to eject the entirety of the liquid pharmaceutical. Therefore, the greater of the two pressures is defined as the push pressure necessary to accomplish both functions.

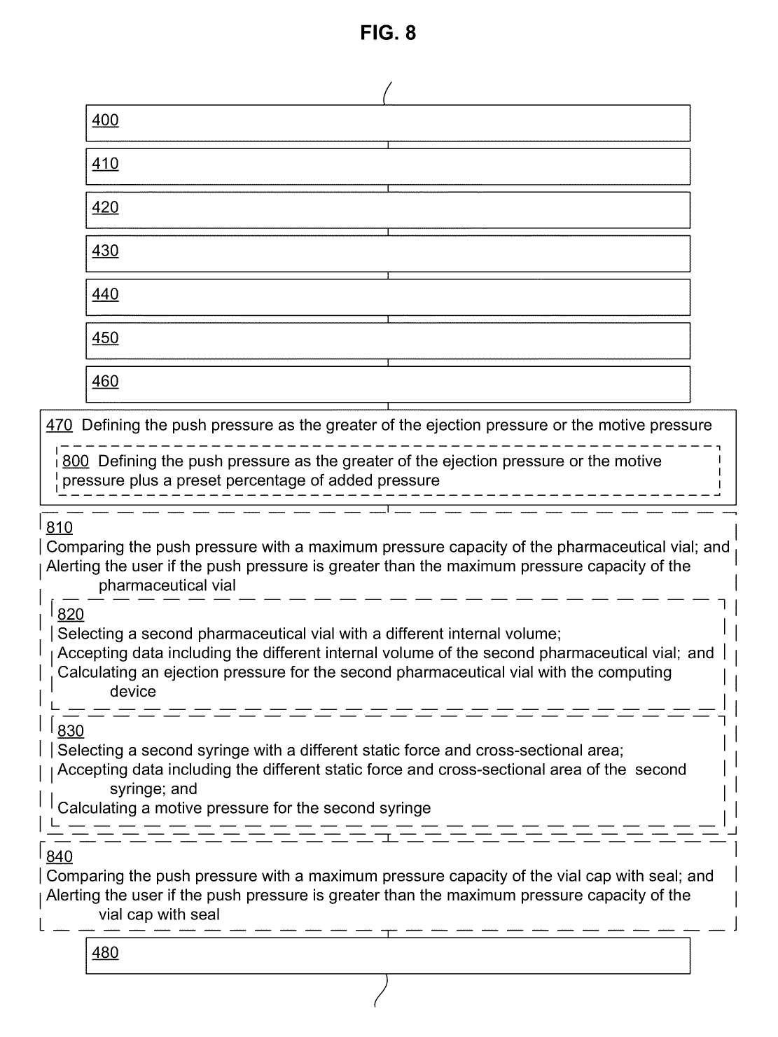

FIG. 8 illustrates further aspects of a method for calculating a push pressure of a pharmaceutical vial with a syringe. In an aspect, the method further includes defining the push pressure as the greater of the ejection pressure or the motive pressure plus a preset percentage of added pressure, as shown in block 800. In an aspect, the preset percentage of added pressure is a preset percentage of pressure above atmospheric pressure. In an aspect, the preset percentage of added pressure is about 0.1% to about 50% above the greater of the ejection pressure or the motive pressure. For example, the preset percentage of added pressure is about 0.1%, 0.2%, 0.5%, 0.7%, 1%, 2%, 4%, 6%, 8%, 10%, 15%, 20%, 25%, 30%, 35%, 40%, 45%, or 50% above the greater of the ejection pressure or the motive pressure. In an aspect, the preset percentage of added pressure is calculated to completely eject the entirety of the single dose volume of liquid pharmaceutical plus an additional volume of gas into the syringe. In an aspect, the preset percentage of added pressure is calculated to completely eject the entirety of the single dose volume of liquid pharmaceutical plus an additional volume of gas into the syringe and to equilibrate with atmospheric pressure. In an aspect, the preset percentage of added pressure is calculated to prevent dripping of the single dose volume of liquid pharmaceutical from the end of the needle once the needle portion is removed from the pharmaceutical vial.

In an aspect, the method further includes comparing the push pressure with a maximum pressure capacity of the pharmaceutical vial, and alerting the user if the push pressure is greater than the maximum pressure capacity of the pharmaceutical vial, as shown in block 810. In an aspect, the push pressure may exceed the maximum pressure capacity of the pharmaceutical vial, compromising the integrity of the pharmaceutical vial and its contents. In an aspect, the push pressure is altered by altering the ejection pressure by altering the pharmaceutical vial type. In an aspect, the push pressure is altered by altering the motive pressure by altering the syringe type. In an aspect, the method further includes in block 820 selecting a second pharmaceutical vial with a different internal volume, accepting data including the different internal volume of the second pharmaceutical vial, and calculating an ejection pressure for the second pharmaceutical vial with the computing device. In an aspect, the method includes in block 830 selecting a second syringe with a different static force and cross-sectional area, accepting data including the different static force and cross-sectional area of the second syringe, and calculating a motive pressure for the second syringe.

In an aspect, the method further includes in block 840 comparing the push pressure with a maximum pressure capacity of the vial cap with seal, and alerting the user if the push pressure is greater than the maximum pressure capacity of the vial cap with seal. For example, the push pressure may exceed the maximum pressure capacity of the vial cap and/or seal, compromising the integrity of the vial cap and/or seal and the contents of the pharmaceutical vial. In an aspect, the method includes selecting a second vial cap with seal with a different maximum pressure capacity compatible with the calculated push pressure.

The method further includes reporting the push pressure to a user. In an aspect, the method includes reporting the push pressure to a user through a user interface, e.g., a display, operably coupled to the computing device. In an aspect, the method includes reporting the push pressure to a user that includes a vialing apparatus. For example, the method can include sending the calculated push pressure from a computing device to an operably coupled vialing apparatus. For example, the method can include sending the calculated push pressure to a user, e.g., a vial technician or a vialing apparatus, in a remote location through the Internet or other web-based communication link.

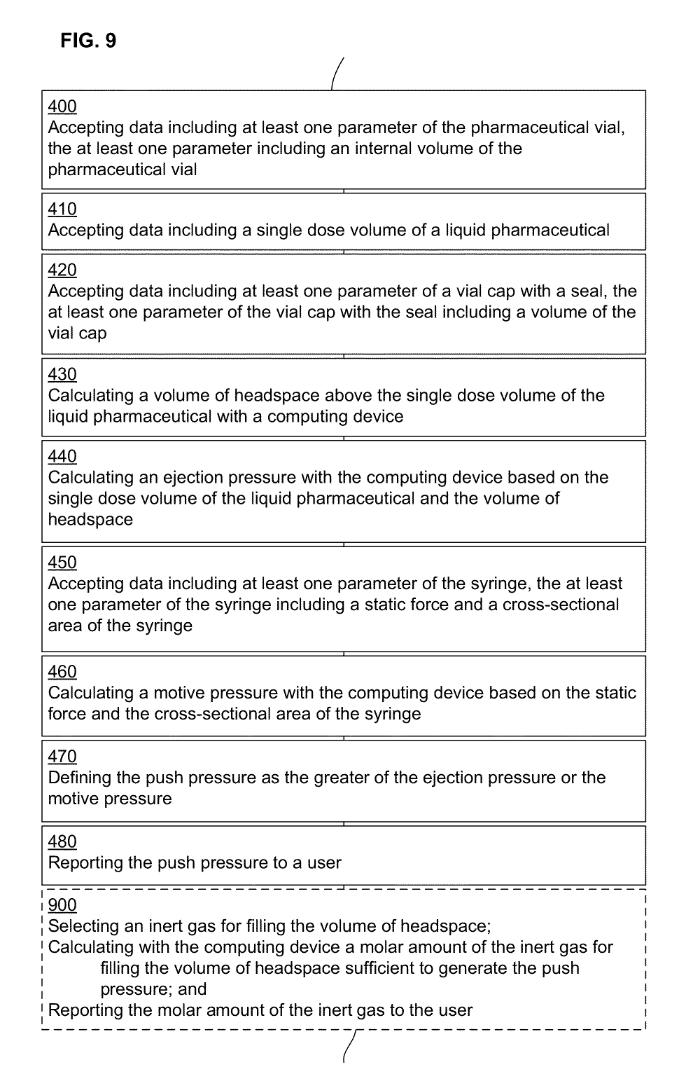

FIG. 9 shows further aspects of a method such as shown in FIG. 4. In an aspect, the method further includes in block 900, selecting an inert gas for filling the volume of headspace; calculating with the computing device a molar amount of the inert gas for filling the volume of headspace sufficient to generate the push pressure; and reporting the molar amount of the inert gas to the user. In an aspect, the inert gas includes at least one of argon, helium, or nitrogen.

In an aspect, selecting an inert gas for the volume of headspace over the liquid pharmaceutical is determined based on the solubility of an inert gas in the liquid pharmaceutical. In some embodiments, it is desirable to have as little inert gas dissolved in the liquid pharmaceutical as possible so as to prevent the inert gas from coming out of the liquid pharmaceutical, i.e., creating bubbles, either during the ejection of the single dose volume of liquid pharmaceutical into the syringe or after injection of the single dose volume of liquid pharmaceutical into an individual. In an aspect, the selected inert gas follows Henry's law which states that “At a constant temperature, the amount of a given gas that dissolves in a given type and volume of liquid is directly proportional to the partial pressure of that gas at equilibrium with that liquid.” Henry's law may be expressed in mathematical terms as p=k_{H}c, wherein p is the partial pressure of the gas above the liquid, c is the concentration of the gas in the liquid, and k_{H} is referred to as Henry's law constant, the latter of which varies depending upon the gas. In general, the higher the pressure in the pharmaceutical vial, the more likely a portion of the inert gas will become dissolved in the single dose volume of liquid pharmaceutical.

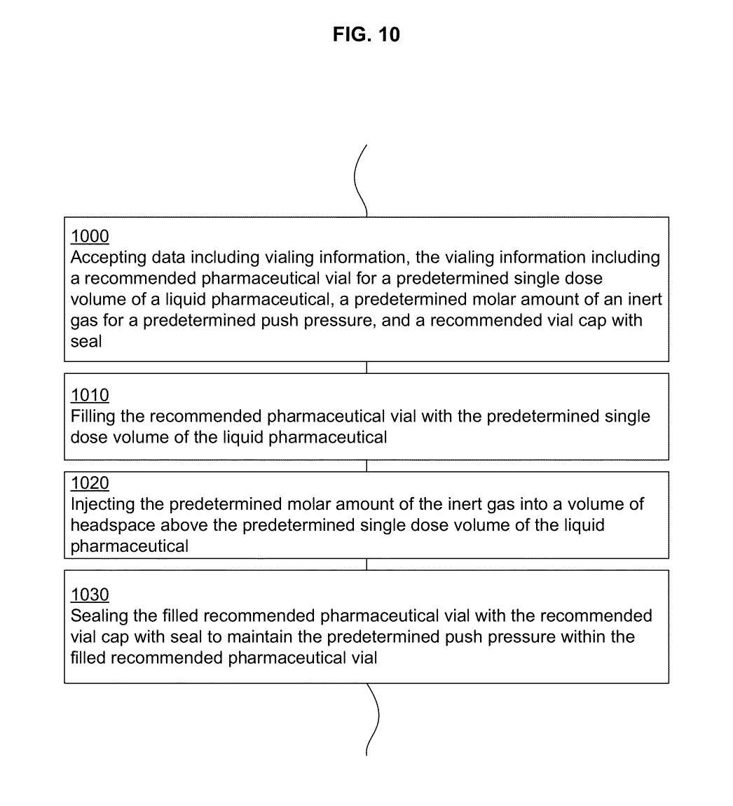

FIG. 10 illustrates aspects of a method of filling a pharmaceutical vial. The method includes in block 1000, accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal; in block 1010, filling the recommended pharmaceutical vial with the predetermined single dose volume of the liquid pharmaceutical; in block 1020, injecting the predetermined molar amount of the inert gas into a volume of headspace above the predetermined single dose volume of the liquid pharmaceutical; and in block 1030, sealing the filled recommended pharmaceutical vial with the recommended vial cap with seal to maintain the predetermined push pressure within the filled recommended pharmaceutical vial.

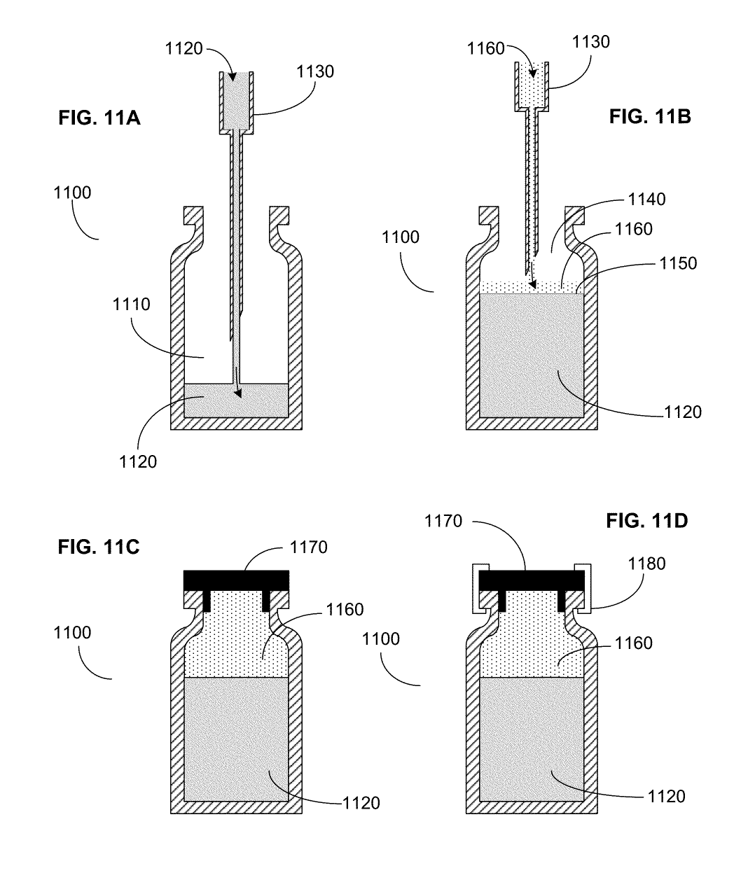

FIGS. 11A-11D are schematic illustrations of a method of filling a pharmaceutical vial such as shown in FIG. 10. FIG. 11A shows a cross-section through pharmaceutical vial 1100. Pharmaceutical storage region 1110 is being filled with a single dose volume of liquid pharmaceutical 1120, e.g., a vaccine or therapeutic agent, through fill apparatus 1130. FIG. 11B shows a cross-section through pharmaceutical vial 1100 with a single dose volume of liquid pharmaceutical 1120. A volume of headspace 1140 above surface 1150 of single dose volume of liquid pharmaceutical 1120 is being filled with inert gas 1160, e.g., argon or nitrogen, through fill apparatus 1130. In some embodiments, the method includes using a liquid fill apparatus and then an inert gas fill apparatus. A molar amount of inert gas 1160 to achieve a calculated push pressure is added to volume of headspace 1140. FIG. 11C shows a cross-section through pharmaceutical vial 1100 with a single dose volume of liquid pharmaceutical 1120 and inert gas 1160 in volume of headspace 1140. Pharmaceutical vial 1100 has been further fitted with vial cap 1170, e.g., a rubber stopper. FIG. 11D shows a cross-section through pharmaceutical vial 1100 with a single dose volume of liquid pharmaceutical 1120 and inert gas 1160 fitted with vial cap 1170. Vial cap 1170 is further sealed to pharmaceutical vial 1100 with seal 1180, e.g., an aluminum crimp seal, to maintain the push pressure within sealed pharmaceutical vial 1100.

The method of filling a pharmaceutical vial includes accepting data including vialing information. The vialing information includes a recommended pharmaceutical vial type to accommodate a predetermined single dose volume of a liquid pharmaceutical. For example, the vialing information can include a recommended pharmaceutical vial type appropriately sized for the volume of liquid pharmaceutical to accommodate a reasonable push pressure, e.g., a pressure that does not exceed the pressure capacity of either the pharmaceutical vial or the vial cap with seal. The vialing information further includes a predetermined molar amount of an inert gas to reach the predetermined push pressure as well as a recommended vial cap with seal to maintain the push pressure in the pharmaceutical vial. In an aspect, the method includes accepting the data from at least one look-up table. In an aspect, the method includes accepting the data from a user input. For example, the method can include having a vialing technician or other operator input the vialing information using a user interface, e.g., a keyboard or touchpad and display. In an aspect, the method includes accepting the data from a computing device. For example, the method can include accepting data including the vialing information from a computing device used to calculate the push pressure for a pharmaceutical vial with syringe. In an aspect, the computing device is operably coupled to a vialing apparatus. For example, the computing device can be a stand-alone computer with a user input, e.g., a keyboard, and a display that is connected to a separate vialing device. In an aspect, the computing device is incorporated into the vialing device. For example, the computing device can include a controller of a vialing device. In an aspect, the computing device is a remote computing device linked to a vialing apparatus through a wired or wireless communication link. For example, the method can include accepting the data from a remote location through the Internet or other web-based communication link.

The method includes filling the recommended pharmaceutical vial with a predetermined single dose volume of a liquid pharmaceutical. In an aspect, the method includes filling the recommended pharmaceutical vial with a predetermined single dose volume of the liquid pharmaceutical that is less than or equal to a preset percentage of an internal volume of the recommended pharmaceutical vial. In general, the greater the volume of the liquid pharmaceutical relative to the internal volume of the recommended pharmaceutical vial, the greater the push pressure required to eject the entirety of the liquid pharmaceutical out of the pharmaceutical vial. In an aspect, the preset percentage of the internal volume of the recommended pharmaceutical vial ranges from about 10% to about 90%. For example, the preset percentage of the internal volume can be 10%, 15%, 20%, 25%, 30%, 35%, 40%, 45%, 50%, 55%, 60%, 65%, 70%, 75%, 80%, 85%, or 90%. In an aspect, the preset percentage of the internal volume of the pharmaceutical vial is no greater than 80%.

In an aspect, the method includes filling the recommended pharmaceutical vial with the single dose volume of the liquid pharmaceutical and/or with the molar amount of inert gas using an automated vialing apparatus including a controller. In an aspect, the method includes filling the recommended pharmaceutical vial with a vialing apparatus under sterile conditions, e.g., in a sterile room or a sterile enclosure. In an aspect, the method includes filling the recommended pharmaceutical vial with a vialing apparatus under positive pressure conditions, e.g., in a room or enclosure under positive pressure. In an aspect, the vialing apparatus is completely contained within a sterile environment, e.g., a fully enclosed container or isolator. In an aspect, the method includes using a commercially available vialing apparatus (from, e.g., Optima Machinery Corporation, Green Bay, Wis.).

In an aspect, the method includes using a vialing apparatus capable of automatically filling the recommended pharmaceutical vial with the single dose volume of liquid pharmaceutical, injecting the molar amount of inert gas, and sealing the recommended pharmaceutical vial. In an aspect, the vialing apparatus includes a controller, e.g., a computing device, to receive data signals corresponding to the amount of liquid pharmaceutical fill, the amount of inert gas fill, desired internal gas pressure, and the like. The controller may include a computer executing suitable software and having suitable interface components to receive user input, receive and process instrumentation signals and exert control over the various described apparatus components. The control system may further comprise one or more additional control components in communication with and/or responsive to the computer to more directly interact with various system components associated with the vialing apparatus. The controller may control the pressure and flow rate at which the inert gas is added to the pharmaceutical vial. The controller may control the temperature at which the inert gas is added to the pharmaceutical vial.

In an aspect, the method includes injecting the predetermined molar amount of the inert gas into the volume of headspace above the predetermined single dose volume of the liquid pharmaceutical. In an aspect, the method includes injecting a predetermined molar amount of argon into the volume of headspace. In an aspect, the method includes injecting a predetermined molar amount of nitrogen into the volume of headspace. In an aspect, the method includes injecting a predetermined molar amount of helium into the volume of headspace. In an aspect, the method includes filtering the inert gas prior to injection into the pharmaceutical vial. In an aspect, the method includes replacing the air in the volume of headspace prior to injecting the molar amount of the inert gas. For example, the volume of headspace can be cleared of air by purging the volume of headspace with argon under atmospheric pressure. Argon is heavier than oxygen and sinks into the vial, displacing the oxygen in the air. For example, the volume of headspace can be cleared of air by evacuating the volume of headspace of air without evaporating the liquid, and then filling the volume of headspace with the inert gas as described in U.S. Patent Application 2007/0062162 to Lehmann titled “Method and Apparatus for Cleaning Containers to be Sealed and Containing a Filler from Oxygen Gas,” which is incorporated herein by reference.

In an aspect, the method includes injecting the predetermined molar amount of the inert gas directly into the volume of headspace. For example, the method can include inserting a filling apparatus through the opening of the pharmaceutical vial and into the volume of headspace. In an aspect, the method includes partially closing the opening of the pharmaceutical vial while injecting the predetermined molar amount of the inert gas. For example, the vial cap can be loosely placed in the opening, allowing for a filling apparatus to pass between a portion of the vial cap and the inner wall of the pharmaceutical vial. In an aspect, the method includes simultaneously filling the volume of headspace with inert gas as the pharmaceutical vial is being capped and sealed. For example, the volume of headspace can be filled with inert gas using a commercial available vacuum stoppering system (from e.g., Chase-Logeman Corporation, Greensboro, N.C.). In an aspect, the method includes injecting the predetermined molar amount of inert gas indirectly into the volume of headspace by equilibrating the recommended pharmaceutical vial in a sealed vialing apparatus in an atmosphere including the inert gas. In an aspect, the inert gas is added to a chamber containing the pharmaceutical vials. For example, the pharmaceutical vials lacking vial caps with seals, e.g., open to the atmosphere, are placed in a chamber, into which is pumped the inert gas. A pressure regulator may be set a controller of the vialing apparatus to supply inert gas into the chamber at the requisite pressures. A pressure gauge may be used to determine the pressure within the chamber. The sealing portion of the method may be carried out within the pressurized chamber to ensure that the pressure, e.g., the push pressure, in the pharmaceutical vials is maintained after sealing.

In an aspect, the inert gas is added to each individual pharmaceutical vial after the pharmaceutical vial had been sealed. In an aspect, the method includes injecting at least a portion of the predetermined molar amount of inert gas into the volume of headspace after sealing the recommended pharmaceutical vial with the vial cap with seal, and resealing the vial cap with seal with an energy source to maintain the push pressure in the recommended pharmaceutical vial. For example, the method may include filling the pharmaceutical vial with the liquid pharmaceutical, sealing the pharmaceutical vial, and then adding the requisite amount of inert gas to the sealed vial. In an aspect, the source of inert gas is attached through a conduit, e.g., tubing, to a portion capable of piercing the needle-penetrable portion of the seal. In an aspect, the source of the inert gas also includes a means to measure the amount of inert gas that is leaving the source and entering the vial. In an aspect, the source of inert gas includes a meter. In an aspect, the portion capable of piercing the needle-penetrable portion of the seal includes a pressure sensor, e.g., a pressure transducer, which is able to measure the internal gas pressure as the pharmaceutical vial is filled with the inert gas. In an aspect, the pressure and/or the composition of gas in the volume of headspace is monitored. For example, the pressure and/or composition of gas in the volume of headspace can be assessed using a nondestructive laser-based analysis system (from, e.g., LIGHTHOUSE, Charlottesville, Va.). See, e.g., Zuleger et al. (2012) “Container/Closure Integrity Testing and the Identification of a suitable Vial/stopper combination for Low-Temperature Storage at −80° C.” PDA J Pharm Sci and Tech 66:453-465, which is incorporated herein by reference.

In an aspect, the method includes labeling the recommended pharmaceutical vial to include a recommended syringe type. In an aspect, the method includes labeling the recommended pharmaceutical vial with a vial code to match a syringe code. In an aspect, the method includes labeling the recommended pharmaceutical vial with at least one of a color, a bar code, or an RFID tag to match the syringe code. In an aspect, the push pressure is calculated based on the combined properties of the pharmaceutical vial and the syringe for use with the pharmaceutical vial. In an aspect, the push pressure is calculated based on the combined properties of the pharmaceutical vial, the syringe for use with the pharmaceutical vial, the volume or headspace, and the single dose volume of the liquid pharmaceutical.

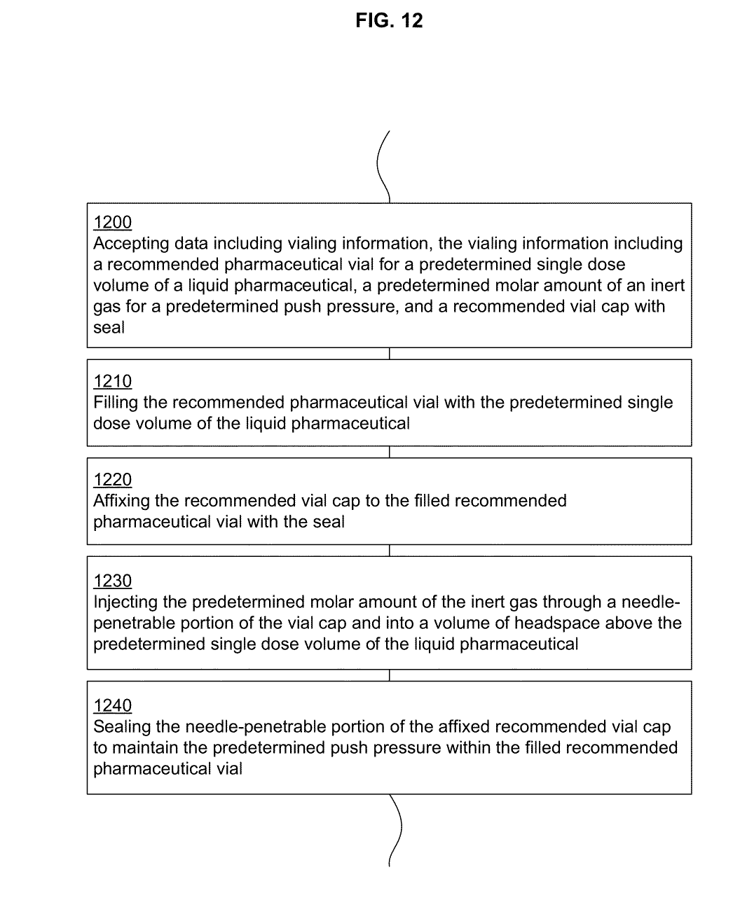

In some embodiments, the pharmaceutical vial including a single dose volume of liquid pharmaceutical is sealed prior to injecting a molar amount of an inert gas into the volume of head space to generate the push pressure. FIG. 12 illustrates aspects of a method of filling a pharmaceutical vial. The method includes in block 1200 accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal; in block 1210, filling the recommended pharmaceutical vial with the predetermined single dose volume of the liquid pharmaceutical; in block 1220, affixing the recommended vial cap to the filled recommended pharmaceutical vial with the seal; in block 1230, injecting the predetermined molar amount of the inert gas through a needle-penetrable portion of the affixed vial cap and into a volume of headspace above the predetermined single dose volume of the liquid pharmaceutical; and in block 1240, sealing the needle-penetrable portion of the affixed recommended vial cap to maintain the predetermined push pressure within the filled recommended pharmaceutical vial.

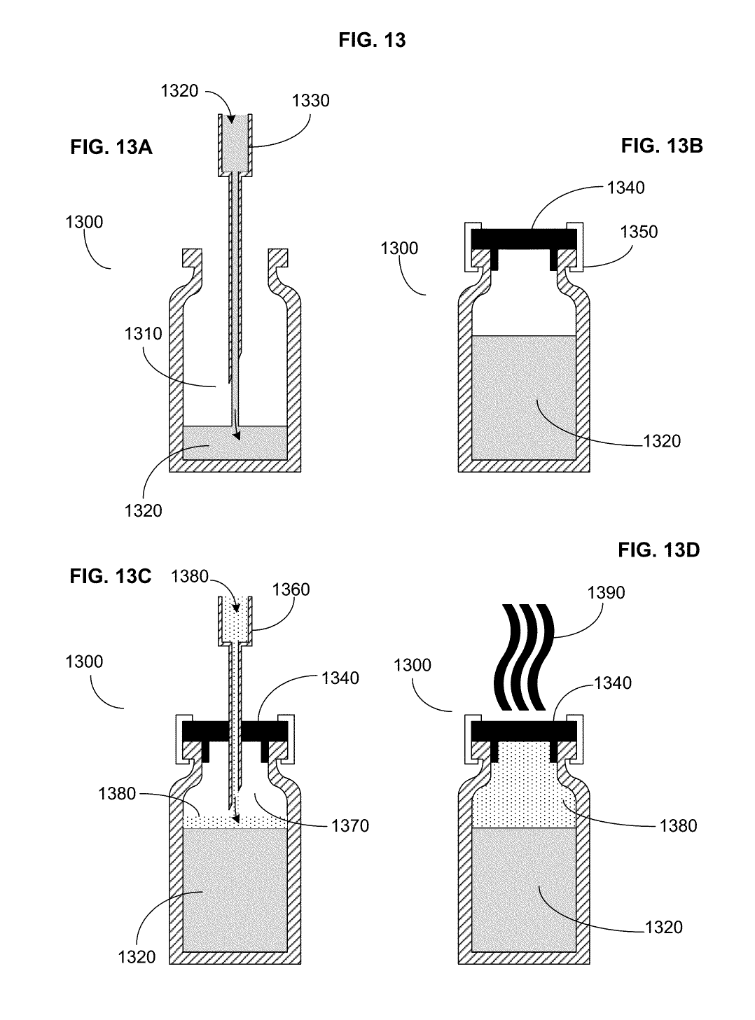

FIGS. 13A-13D are schematic illustrations of a method of filling a pharmaceutical vial such as shown in FIG. 12. FIG. 13A shows a cross-section through pharmaceutical vial 1300. Pharmaceutical storage region 1310 is being filled with a single dose volume of liquid pharmaceutical 1320, e.g., a vaccine or therapeutic agent, through fill apparatus 1330. FIG. 13B shows a cross-section through pharmaceutical vial 1300 with a single dose volume of liquid pharmaceutical 1320. Pharmaceutical vial 1300 is topped with vial cap 1340, e.g., a thermal-sensitive rubber stopper, and sealed with seal 1350, e.g., an aluminum crimp. FIG. 13C shows a cross-section through pharmaceutical vial 1300 with a single dose volume of liquid pharmaceutical 1320 and volume of headspace 1370. Volume of headspace 1370 is shown being filled with inert gas 1380, e.g., argon or nitrogen, through fill apparatus 1360 inserted through vial cap 1340. A molar amount of inert gas 1380 to achieve a calculated or recommended push pressure is added to volume of headspace 1370. FIG. 13D shows a cross-section through pharmaceutical vial 1300 with a single dose volume of liquid pharmaceutical 1320 and inert gas 1380 in volume of headspace 1370. Energy 1390, e.g., laser energy or heat, is applied to vial cap 1340 to seal the puncture created by inserting filling apparatus 1360 through vial cap 1340 to fill the volume of headspace with inert gas 1380. Sealing the puncture maintains the push pressure in pharmaceutical vial 1300 created by inert gas 1380.

In an aspect, the method includes accepting the data including the vialing information from at least one look-up table or from a user input. In an aspect, the method includes accepting the data including the vialing information from a computing device. In an aspect, the method includes accepting the data including the vial information into a controller operably coupled to a vialing apparatus.

In an aspect, the method includes filling the recommended pharmaceutical vial with a predetermined single dose volume of the liquid pharmaceutical that is less than or equal to a preset percentage of an internal volume of the recommended pharmaceutical vial. In an aspect, the method includes filling the recommended pharmaceutical vial with a predetermined single dose volume of the liquid pharmaceutical that is 80% or less of an internal volume of the recommended pharmaceutical vial. In an aspect, the method includes filling the recommended pharmaceutical vial using an automated vialing apparatus operably coupled to a controller.

The method includes affixing the recommended vial cap to the filled recommended pharmaceutical vial with the seal. For example, the method can include placing a rubber stopper into the opening of the pharmaceutical vial and affixing the rubber stopper with an aluminum crimp. For example, the method can include screwing a vial cap including a needle-penetrable septum onto the pharmaceutical vial.

The method includes injecting the molar amount of inert gas through a needle-penetrable portion of the affixed vial cap. For example, the vial cap can include a rubber stopper that fits snuggly into the opening of the pharmaceutical vial and includes a portion that is penetrable by a needle. In an aspect, the method includes injecting a molar amount of at least one of helium, argon, or nitrogen through the needle-penetrable portion of the affixed vial cap. In an aspect, the method includes injecting a molar amount of at least one of another inert gas, non-limiting examples of which include neon, krypton, or xenon. In an aspect, the method includes injecting a molar amount of carbon dioxide. In an aspect, the method includes having a venting means for clearing atmospheric gases, e.g., primarily oxygen, out of the volume of headspace. This is of particular importance if one or more components of the liquid pharmaceutical are susceptible to oxidation. In an aspect, the method includes inserting a venting device through the needle-penetrable portion of the vial cap, pushing the air out of the volume of headspace, and removing the venting device to continue injecting the desired inert gas.

The method includes sealing the needle-penetrable portion of the affixed recommended vial cap to maintain the predetermined push pressure. In an aspect, the method includes sealing the needle-penetrable portion of the recommended vial cap with an energy source. For example, the method can include sealing the needle-penetrable portion of a thermal-responsive vial cap with a thermal energy source, e.g., a heat gun or a laser. See, e.g., U.S. Pat. No. 6,684,916 to Py titled “Medicament Vial having a Heat-Sealable Cap, and Apparatus and Method for Filling the Vial,” which is incorporated herein by reference.

In an aspect, the method further includes labeling the recommended pharmaceutical vial to include a recommended syringe type. In an aspect, the method includes labeling the recommended pharmaceutical with a vial code to match a syringe code. In an aspect, the method includes labeling the recommended pharmaceutical vial with at least one of a color, a bar code, or a radiofrequency identification (RFID) tag to match the syringe code. A non-limiting example of pharmaceutical vial with a vial code and a syringe with a matching syringe code is illustrated in FIG. 3.

In an aspect, a method of filling pharmaceutical vials can include a method of filling pharmaceutical vials with an automated vialing apparatus. In an aspect, a method of filling pharmaceutical vials includes: selecting a pharmaceutical vial for a predetermined single dose volume of a liquid pharmaceutical from a list of recommended pharmaceutical vials; placing the selected pharmaceutical vial in a filling station of the automated vialing apparatus; filling the selected pharmaceutical vial with the predetermined single dose volume of the liquid pharmaceutical; selecting a molar amount of an inert gas for a recommended push pressure for the selected pharmaceutical and a syringe; filling a volume of headspace above the predetermined single dose volume of the liquid pharmaceutical in the selected pharmaceutical vial with the molar amount of the inert gas for the recommended push pressure; selecting a vial cap with seal for the selected pharmaceutical vial from a list of recommended vial caps with seals; and sealing the selected pharmaceutical vial with the selected vial cap with seal to maintain the recommended push pressure within the pharmaceutical vial.

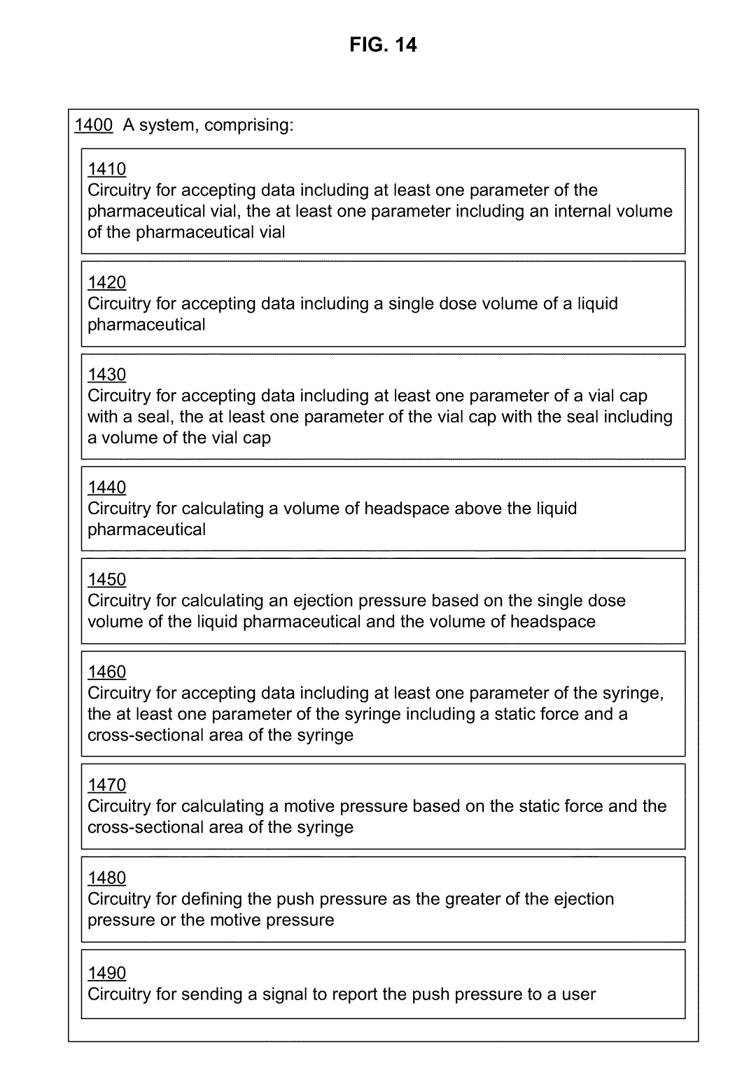

FIG. 14 illustrates aspects of the system for calculating a push pressure of a pharmaceutical vial with a syringe. System 1400 includes circuitry 1410 for accepting data including at least one parameter of the pharmaceutical vial, the at least one parameter including an internal volume of the pharmaceutical vial. System 1400 includes circuitry 1420 for accepting data including a single dose volume of a liquid pharmaceutical. System 1400 includes circuitry 1430 for accepting data including at least one parameter of a vial cap with a seal, the at least one parameter of the vial cap with the seal including a volume of the vial cap. System 1400 includes circuitry 1440 for calculating a volume of headspace above the single dose volume of the liquid pharmaceutical. System 1400 includes circuitry 1450 for calculating an ejection pressure based on the single dose volume of the liquid pharmaceutical and the volume of the headspace. System 1400 includes circuitry 1460 for accepting data including at least one parameter of the syringe, the at least one parameter of the syringe including a static force and a cross-sectional area of the syringe. System 1400 includes circuitry 1470 for calculating a motive pressure based on the static force and the cross-sectional area of the syringe. System 1400 includes circuitry 1480 for defining the push pressure as the greater of the ejection pressure or the motive pressure. System 1400 includes circuitry 1490 for sending a signal to report the push pressure to a user.

In an aspect, system 1400 further includes: circuitry for selecting an inert gas, e.g., argon or nitrogen, for filling the volume of headspace; circuitry for calculating a molar mount of the inert gas for filling the volume of headspace sufficient to generate the push pressure; and circuitry for sending a signal to report the molar amount of the inert gas to the user.

System 1400 includes circuitry 1410 for accepting data including at least one parameter of the pharmaceutical vial including an internal volume of the pharmaceutical vial. In an aspect, the system includes circuitry for accepting data including at least one of a maximum pressure capacity, a vial identification code, or an internal surface property. In an aspect, the system includes circuitry for accepting the data from a look-up table. In an aspect, the system includes circuitry for accepting the data from a user input.

System 1400 includes circuitry 1420 for accepting data including the single dose volume of the liquid pharmaceutical. In an aspect, the system includes circuitry for accepting the data from a look-up table. For example, the system can include circuitry for accepting data from a look-up table provided by a manufacturer of the liquid pharmaceutical. In an aspect, the system includes circuitry for accepting the data from a user input. For example, the system can include circuitry for accepting the data from keyboard or touchpad entries. For example, the system can include circuitry for accepting the data from a remote source, e.g., the Internet or other web connection.

In an aspect, the system further includes circuitry for comparing the single dose volume of the liquid pharmaceutical to the internal volume of the pharmaceutical vial, and circuitry for alerting the user if the single dose volume of the liquid pharmaceutical is greater than the internal volume of the pharmaceutical vial. In an aspect, the system includes circuitry for comparing the single dose volume of the liquid pharmaceutical to the internal volume of the pharmaceutical vial and that portion of the volume of the vial cap that is inserted into to the pharmaceutical vial, and circuitry for alerting the user if the single dose volume of the liquid pharmaceutical is greater than the internal volume of the pharmaceutical vial and that portion of the volume of the vial cap that is inserted into the pharmaceutical vial. For example, a selected vial may have an internal volume sufficient for the single dose volume of the liquid pharmaceutical but not sufficient if the portion of the volume of the vial cap that is inserted into the pharmaceutical vial is taken into account.

In an aspect, the system further includes circuitry for comparing the single dose volume of the liquid pharmaceutical to the internal volume of the pharmaceutical vial, and alerting the user if the single dose volume of the liquid pharmaceutical is greater than a preset percentage of the internal volume of the pharmaceutical vial. In general, the greater the volume of the liquid pharmaceutical relative to the internal volume of the pharmaceutical vial, the greater the push pressure required to eject the entirety of the liquid pharmaceutical out of the pharmaceutical vial. In an aspect, the preset percentage of the internal volume of the pharmaceutical vial ranges from about 10% to about 90%. For example, the preset percentage of the internal volume can be 10%, 15%, 20%, 25%, 30%, 35%, 40%, 45%, 50%, 55%, 60%, 65%, 70%, 75%, 80%, 85%, or 90%. In an aspect, the preset percentage of the internal volume of the pharmaceutical vial is no greater than 80%.

System 1400 includes circuitry 1430 for accepting data including at least one parameter of a vial cap with a seal, the at least one parameter of the vial cap with seal including a volume of the vial cap. In an aspect, the system further includes circuitry for accepting data including at least one of: a maximum pressure capacity, a cap identification code, or a surface property of the vial cap with the seal. In an aspect, the system includes circuitry for accepting the data from a look-up table. In an aspect, the system includes circuitry for accepting the data from a user input, e.g., a keyboard or touchpad operably connect to the computing device.

System 1400 includes circuitry 1440 for calculating a volume of headspace above the single dose volume of the liquid pharmaceutical. In an aspect, a system includes circuitry to calculate the volume of headspace above the liquid pharmaceutical based on the single dose volume of the liquid pharmaceutical, the internal volume of the pharmaceutical vial, and at least a portion of the volume of the vial cap. In an aspect, the system includes circuitry for subtracting from the internal volume of the pharmaceutical vial the single dose volume of the liquid pharmaceutical and a portion of the volume of the vial cap intended for positioning adjacent to the internal volume of the pharmaceutical vial.

System 1400 includes circuitry 1450 for calculating an ejection pressure based on the single dose volume of the pharmaceutical and the volume of headspace. In an aspect, the system includes circuitry for calculating a pressure required in the pharmaceutical vial under a sealed condition to eject the entirety of the single dose volume of the liquid pharmaceutical through a flow path created by the syringe. In an aspect, the system includes circuitry for performing one or more calculations. In an aspect, the system includes circuitry for performing pressure/volume calculations, non-limiting examples of which have been described above herein.

System 1400 includes circuitry 1460 for accepting data including at least one parameter of the syringe. In an aspect, the system includes circuitry for accepting the data including a static force and a cross-sectional area of the syringe. In an aspect, the system includes circuitry for accepting the data including at least one of a volume capacity or a syringe identification code. In an aspect, the system includes circuitry for accepting data including at least one parameter of a syringe with a volume capacity greater than the single dose volume of the liquid pharmaceutical. In an aspect, the system includes circuitry for accepting data including at least one parameter of a syringe listed on a look-up table.

In an aspect, the system further includes circuitry for comparing the single dose volume of the pharmaceutical with a volume capacity of the syringes, and circuitry for alerting the user if the single dose volume of the liquid pharmaceutical is greater than the volume capacity of the syringe.

In an aspect, the system further includes circuitry for comparing the calculated push pressure with a maximum pressure capacity of the pharmaceutical vial, and circuitry for alerting the user if the calculated push pressure is greater than the maximum pressure capacity of the pharmaceutical vial.

In an aspect, the system includes circuitry for re-calculating the push pressure using a different pharmaceutical vial if the comparisons indicate that the current pharmaceutical vial does not have sufficient pressure capacity to contain the needed push pressure. In an aspect, the system includes circuitry for selecting a second pharmaceutical vial with a different internal volume, circuitry for accepting data including the different internal volume of the second pharmaceutical vial, and circuitry for calculating an ejection pressure for the second pharmaceutical vial.

In an aspect, the system includes circuitry for selecting a second syringe with a different static force and cross-sectional area, circuitry for accepting data including the different static force and cross-sectional area of the second syringe, and circuitry for calculating a motive pressure for the second syringe.

In an aspect, the system includes circuitry for comparing the calculated push pressure with a maximum pressure capacity of the vial cap with the seal, and circuitry for alerting the user if the calculated push pressure is greater than the maximum pressure capacity of the vial cap with the seal.

System 1400 includes circuitry 1480 for defining the push pressure as the greater of the ejection pressure or the motive pressure. In an aspect, the system includes circuitry for defining the push pressure as the greater of the ejection pressure or the motive pressure plus a preset percentage of added pressure. For example, the preset percentage of added pressure may include added pressure to ensure that the pressure inside the pharmaceutical vial after ejecting the entirety of the liquid pharmaceutical is greater than atmospheric pressure. For example, the preset percentage of added pressure may include added pressure that ejects the entirety of the liquid pharmaceutical plus a volume of gas. For example, the preset percentage of added pressure may include added pressure that ejects the entirety of the liquid pharmaceutical as well as 0.1 to 0.5 ml of gas.

The system includes circuitry for sending a signal to report the push pressure to the user. In an aspect, the system includes circuitry for sending a signal to report the push pressure on a display screen of the computing device. In an aspect, the system includes circuitry for sending a signal to report the push pressure to a controller operably coupled to a vialing apparatus. For example, the system can include circuitry to send a signal to report the push pressure to a computing device operably coupled to a vialing apparatus. For example, the system can include circuitry to send a signal to report the push pressure to a user interface, e.g., a display, of a vialing apparatus.

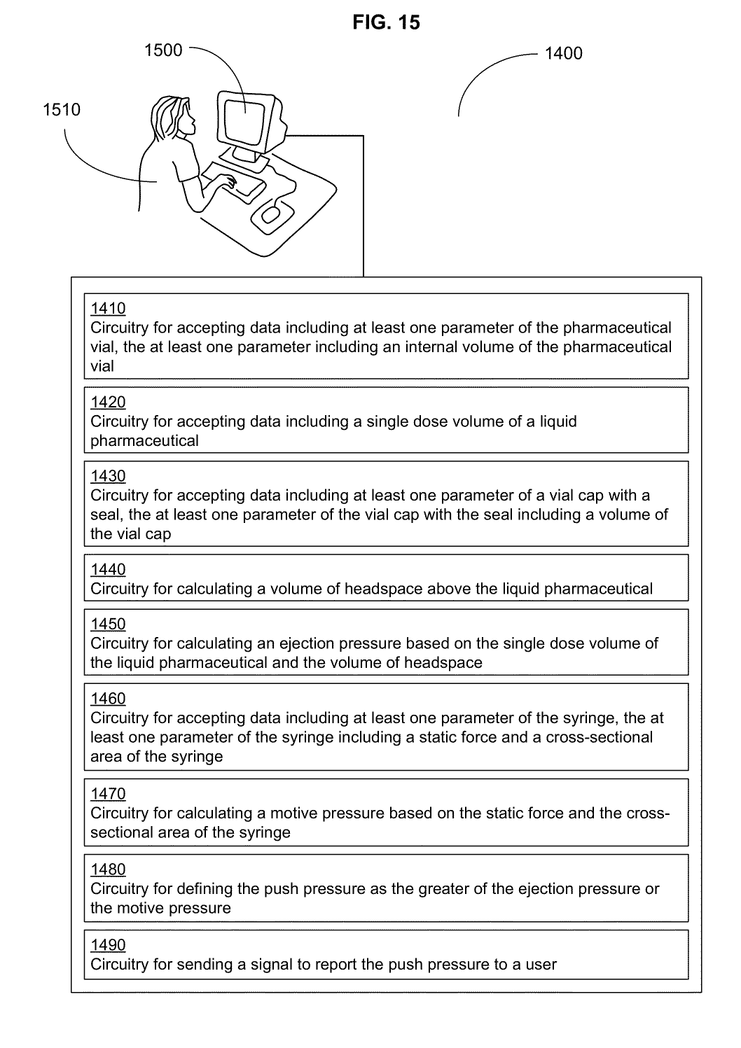

In an aspect, system 1400 includes a computing device. FIG. 15 illustrates further aspects of a system for calculating a push pressure of a pharmaceutical vial with a syringe including a computing device. System 1400 includes computing device 1500, e.g., a desk-top computer, and circuitry such as shown in FIG. 14 and described in related text. In an aspect, user 1510 interacts with computing device 1500 to access the circuitry to calculate the push pressure of the pharmaceutical vial with the syringe. System 1400 including computing device 1500 includes: circuitry 1410 for accepting data including at least one parameter of the pharmaceutical vial, the at least one parameter including an internal volume of the pharmaceutical vial; circuitry 1420 for accepting data including a single dose volume of a liquid pharmaceutical; circuitry 1430 for accepting data including at least one parameter of a vial cap with a seal, the at least one parameter of the vial cap with the seal including a volume of the vial cap; circuitry 1440 for calculating a volume of headspace above the single dose volume of the liquid pharmaceutical; circuitry 1450 for calculating an ejection pressure based on the single dose volume of the liquid pharmaceutical and the volume of the headspace; circuitry 1460 for accepting data including at least one parameter of the syringe, the at least one parameter of the syringe including a static force and a cross-sectional area of the syringe; circuitry 1470 for calculating a motive pressure based on the static force and the cross-sectional are of the syringe; circuitry 1480 for defining the push pressure as the greater of the ejection pressure or the motive pressure; and circuitry 1490 for sending a signal to report the push pressure to a user.

In an aspect, system 1400 includes computing device 1500. In an aspect, computing device 1500 includes circuitry for accepting data, calculating the ejection pressure and the motive pressure, and defining the push pressure of a pharmaceutical vial for a syringe. In an aspect, computing device 1500 further includes: circuitry for selecting an inert gas for filling the volume of headspace; circuitry for calculating a molar amount of the inert gas for filling the volume of headspace sufficient to generate the push pressure; and circuitry for sending a signal to report the molar amount of the inert gas to the user.

Computing device 1500 can take various forms or be part of an object, and can include, but is not limited to, a computer, a laptop computer, a personal electronic device, a dedicated computing device, a limited resource computing device, a wireless communication device, a mobile wireless communication device, a handheld electronic writing device, a tablet, a digital camera, a scanner, a cell phone, a PDA, an electronic tablet device, a printer, or any other like device that takes information as an input and gives it back to the end-users. In an aspect, computing device 1500 is operably coupled to a vialing apparatus. In an aspect, computing device 1500 is incorporated into a vialing apparatus.

In an aspect, computing device 1600 includes a processing unit, a system memory, and a system bus that couples various system components including the system memory to the processing unit. The processing unit can include a microprocessor, a central processing unit (CPU), a digital signal processor (DSP), an application-specific integrated circuit (ASIC), a field programmable gate entry (FPGA), or the like, or any combinations thereof, and can include discrete digital or analog circuit elements or electronics, or combinations thereof. In an aspect, the computing device includes one or more ASICs having a plurality of pre-defined logic components. In an aspect, the computing device includes one or more FPGA having a plurality of programmable logic commands.

The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In an aspect, computing device 1500 includes a user interface, e.g., one or more input devices and/or output devices for use by user 1510 to interface with the computing device. The one or more input devices can be used to enter information into the computing device, e.g., at least one parameter of the pharmaceutical vial, a single dose volume of a liquid pharmaceutical, at least one parameter of a vial cap with a seal, and/or at least one parameter of a syringe for use with the pharmaceutical vial. The one or more input devices may be integrated into the computing device or may be one or more peripheral devices operably connected through a wired or wireless connection to the computing device. Non-limiting examples of input devices include a graphical user interface, a display, a keyboard, a keypad, a trackball, a joystick, a touch-screen, a mouse, a microphone, an image scanner, a digital camera, a webcam, a light pen, a bar code reader, a fingerprint scanner, a retinal scanner, a game pad, a stylus pen a switch, a dial, or the like.

The user interface includes one or more output devices over which processed information is viewed as output results, e.g., one or more of the ejection pressure, the motive pressure, the push pressure, or the molar amount of inert gas. The one or more output devices may be integrated into the computing device or may be one or more peripheral devices operably connected through a wired or wireless connection to the computing device. Non-limiting examples of output devices include but are not limited to television screens, computer monitors, liquid crystal displays, audio speakers, audio headphones, and printers.

In an aspect, the one or more input/output devices are connected to the processing unit of the computing device through one or more user input interfaces that are coupled to the system bus, but may be connected by other interfaces and bus structures, such as a parallel port, game port, or a universal serial bus (USB). For example, the input devices and/or output devices, may be connected to the processing unit through a USB port and a USB port interface, to the system bus. Alternatively, the other external input devices and output devices may be connected by other interfaces, such as a parallel port, game port or other port. The computing device 1500 may further include or be capable of connecting to a flash card memory through an appropriate connection port. The computing device 1500 may further include or be capable of connecting with a network through a network port and network interface, and through a wireless port and corresponding wireless interface may be provided to facilitate communication with other peripheral devices, for example, a vialing apparatus. It will be appreciated that the various components and connections shown are examples and other components and means of establishing communication links may be used.

In an aspect, computing device 1500 includes read-only memory (ROM) and random access memory (RAM). A basic input/output system (BIOS), containing the basic routines that help to transfer information between sub-components within computing device 1500, such as during start-up, is stored in the ROM. A number of program modules may be stored in the ROM or RAM, including an operating system, one or more application programs, other program modules and program data.

Computing device 1500 includes computer-readable media products and may include any media that can be accessed by the computing device 1500 including both volatile and nonvolatile media, removable and non-removable media. By way of example, and not of limitation, computer-readable media may include non-transitory signal-bearing media. By way of example, and not of limitation, computer-readable media may include computer storage media. By way of further example, and not of limitation, computer-readable media may include a communication media.

Communication media may typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media include wired media, such as a wired network and a direct-wired connection, and wireless media such as acoustic, RF, optical, and infrared media.

Computing device 1500 may also include other removable/non-removable, volatile/nonvolatile computer storage media products implemented in any method or technology for storage of information such as computer-readable instructions, data structures, program modules, or other data. For example, such media includes a non-removable non-volatile memory interface (hard disk interface) reads from and writes, for example, to non-removable, non-volatile magnetic media, or a removable non-volatile memory interface that, for example, is coupled to a magnetic disk drive that reads from and writes to a removable, non-volatile magnetic disk, or is coupled to an optical disk drive that reads from and writes to a removable, non-volatile optical disk, such as a CD ROM. Other removable/nonremovable, volatile/non-volatile computer storage media that can be used in the example operating environment include, but are not limited to, magnetic tape cassettes, magnetic tape, magnetic disk storage, optical disk storage, memory cards, flash memory cards, DVDs, electrically erasable programmable read-only memory (EEPROM), digital video tape, solid state RAM, and solid state ROM or any other medium which can be used to store the desired information and which can be accessed by the computing device 1500. In an aspect, computing device 1500 includes a computer-readable media drive or memory slot configured to accept non-transitory signal-bearing medium (e.g., computer-readable memory media, computer-readable recording media, or the like). In an aspect, a computer storage media may include a group of computer storage media devices. In an aspect, a computer storage media may include an information store. In an aspect, an information store may include a quantum memory, a photonic quantum memory, or atomic quantum memory. Combinations of any of the above may also be included within the scope of computer-readable media.

In an aspect, a program or set of instructions for causing a system to execute any of the disclosed methods can be stored on, for example, a computer-readable recording medium (CRMM), a non-transitory signal-bearing medium, or the like. Non-limiting examples of signal-bearing media include a recordable type medium such as magnetic tape, floppy disk, a hard disk drive, Compact Disc (CD), a Digital Video Disk (DVD), Blu-Ray Disc, digital tape, computer memory, or the like, as well as transmission type medium such as a digital and/or analog communication medium (e.g., fiber optic cable, waveguide, wired communications link, wireless communication link). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, cloud, or the like.

The drives and their associated computer storage media discussed above provide storage of computer-readable instructions, data structures, program modules, and other data for the computing device 1500.

The computing device may operate in a networked environment using logical connections to one or more remote computers. The remote computer may be a personal computer, a server, a router, a network PC, a peer device, or other common network node, and typically includes many or all of the elements described above relative to the computing device 1500. The network logical connections include a local area network (LAN) and a wide area network (WAN), and may also include other networks such as a personal area network (PAN) (not shown). Such networking environments are commonplace in offices, enterprise-wide computer networks, intranets, and the Internet.

In some embodiments, the computing device includes one or more modules optionally operable for communication with one or more input/output components that are configured to relay user output/input. In an aspect, a module includes one or more instances of electrical, electromechanical, software-implemented, firmware-implemented, or other control devices. Such devices include one or more instances of memory, computing devices, antennas, power or other supplies, logic modules or other signaling modules, gauges or other such active or passive detection components, piezoelectric transducers, shape memory elements, micro-electro-mechanical systems (MEMS) elements, or other actuators.

In certain instances, one or more elements of the computing device 1500 may be deemed not necessary and omitted. In other instances, one or more other components may be deemed necessary and added to computing device 1500.

The state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer can opt for a mainly hardware and/or firmware vehicle; alternatively, if flexibility is paramount, the implementer can opt for a mainly software implementation; or, yet again alternatively, the implementer can opt for some combination of hardware, software, and/or firmware. Hence, there are several possible vehicles by which the processes and/or devices and/or other technologies described herein can be effected, none of which is inherently superior to the other in that any vehicle to be utilized is a choice dependent upon the context in which the vehicle will be deployed and the specific concerns (e.g., speed, flexibility, or predictability) of the implementer, any of which can vary. Optical aspects of implementations will typically employ optically-oriented hardware, software, and or firmware.

In some implementations described herein, logic and similar implementations can include software or other control structures. Electronic circuitry, for example, can have one or more paths of electrical current constructed and arranged to implement various functions as described herein. In some implementations, one or more media can be configured to bear a device-detectable implementation when such media hold or transmit device detectable instructions operable to perform as described herein. In some variants, for example, implementations can include an update or modification of existing software or firmware, or of gate arrays or programmable hardware, such as by performing a reception of or a transmission of one or more instructions in relation to one or more operations described herein. Alternatively or additionally, in some variants, an implementation can include special-purpose hardware, software, firmware components, and/or general-purpose components executing or otherwise invoking special-purpose components. Specifications or other implementations can be transmitted by one or more instances of tangible transmission media as described herein, optionally by packet transmission or otherwise by passing through distributed media at various times.

Alternatively or additionally, implementations can include executing a special-purpose instruction sequence or invoking circuitry for enabling, triggering, coordinating, requesting, or otherwise causing one or more occurrences of virtually any functional operations described herein. In some variants, operational or other logical descriptions herein can be expressed as source code and compiled or otherwise invoked as an executable instruction sequence. In some contexts, for example, implementations can be provided, in whole or in part, by source code, such as C++, or other code sequences. In other implementations, source or other code implementation, using commercially available and/or techniques in the art, can be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) can be manifested as a Verilog-type hardware description (e.g., via Hardware Description Language (HDL) and/or Very High Speed Integrated Circuit Hardware Descriptor Language (VHDL)) or other circuitry model which can then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples can be implemented, individually and/or collectively, by a wide range of hardware, software, firmware, or virtually any combination thereof. In one embodiment, several portions of the subject matter described herein can be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

In a general sense, the various embodiments described herein can be implemented, individually and/or collectively, by various types of electro-mechanical systems having a wide range of electrical components such as hardware, software, firmware, and/or virtually any combination thereof; and a wide range of components that can impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs. Examples of electro-mechanical systems include but are not limited to a variety of consumer electronics systems, medical devices, as well as other systems such as motorized transport systems, factory automation systems, security systems, and/or communication/computing systems. Electro-mechanical as used herein is not necessarily limited to a system that has both electrical and mechanical actuation except as context can dictate otherwise.

In a general sense, the various aspects described herein can be implemented, individually and/or collectively, by a wide range of hardware, software, firmware, and/or any combination thereof and can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). The subject matter described herein can be implemented in an analog or digital fashion or some combination thereof.

At least a portion of the devices and/or processes described herein can be integrated into an image processing system. A typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system can be implemented utilizing suitable commercially available components, such as those typically found in digital still systems and/or digital motion systems.

At least a portion of the devices and/or processes described herein can be integrated into a data processing system. A data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system can be implemented utilizing suitable commercially available components, such as those typically found in data computing/communication and/or network computing/communication systems.

The herein described components (e.g., operations), devices, objects, and the discussion accompanying them are used as examples for the sake of conceptual clarity and that various configuration modifications are contemplated. Consequently, as used herein, the specific examples set forth and the accompanying discussion are intended to be representative of their more general classes. In general, use of any specific example is intended to be representative of its class, and the non-inclusion of specific components (e.g., operations), devices, and objects should not be taken limiting.

The herein described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

With respect to the use of substantially any plural and/or singular terms herein, the plural can be translated to the singular and/or from the singular to the plural as is appropriate to the context and/or application. The various singular/plural permutations are not expressly set forth herein for sake of clarity.

In some instances, one or more components can be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) can generally encompass active-state components and/or inactive-state components and/or standby-state components, unless context requires otherwise.

While particular aspects of the present subject matter described herein have been shown and described, changes and modifications can be made without departing from the subject matter described herein and its broader aspects and, therefore, the appended claims are to encompass within their scope all such changes and modifications as are within the true spirit and scope of the subject matter described herein. Terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). If a specific number of an introduced claim recitation is intended, such an intent will be explicitly recited in the claim, and in the absence of such recitation no such intent is present. For example, as an aid to understanding, the following appended claims can contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). Typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

Various non-limiting embodiments are described herein as Prophetic Examples.

### Prophetic Example 1

### Calculating a Push Pressure for a Pharmaceutical Vial for a Syringe

A method using a computing device for calculating a push pressure for a pharmaceutical vial for a syringe is described.

The method includes accepting data regarding the pharmaceutical vial, a single dose volume of a liquid pharmaceutical, a vial cap with seal, and the syringe. The user enters data regarding the internal volume of the pharmaceutical vial; the single dose volume of the liquid pharmaceutical; a volume of the vial cap protruding into the internal volume of the pharmaceutical vial; the volume capacity of the syringe; the static force for initiating movement of the syringe; and the cross-sectional area of the syringe.

The method includes calculating a volume of headspace above the single dose volume of the liquid pharmaceutical using the following calculation:

V_{Headspace}=V_{Vial Internal}−(V_{Liquid}+V_{Vial Cap Internal})

For example, a pharmaceutical vial with a 2 cubic centimeter (2 ml) internal volume, a single dose volume of 1.0 cubic centimeter (1 ml), and a volume of vial cap protruding into the internal volume of the pharmaceutical vial of 0.2 cubic centimeters, the volume of headspace is reported to the user as 0.8 cubic centimeters.

The method includes calculating the ejection pressure required to eject the entirety of the single dose volume of liquid pharmaceutical out of the sealed pharmaceutical vial. The following equation is used to calculate the ejection pressure:

$${P}_{Ejection} = \frac{{V}_{Liquid}}{{V}_{Headspace}} + 1 bar$$

For the pharmaceutical vial of 2 cc with a 1 cc single dose volume of the liquid pharmaceutical and a volume of headspace of 0.8 cc, the ejection pressure is reported to the user as approximately 2.25 bar (or approximately 33 pounds per square inch (psi)).

The method includes calculating the motive pressure required to initiate movement of the plunger in the syringe. The following equations are used to calculate the motive pressure:

$${P}_{Motive} = \frac{{F}_{static force}}{{A}_{cross \text{-} sectional area of plunger}}$$

$$1 psi = \frac{1 lb f}{{( 1 in )}^{2}} = \frac{4.45 N}{{( 0.0254 m )}^{2}}$$

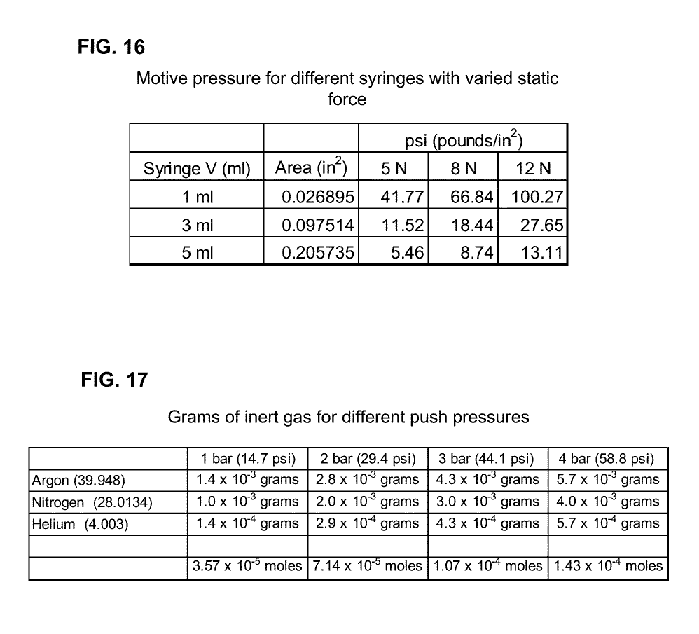

The table in FIG. 16 illustrates calculated motive pressures for commercially available 1 ml, 3 ml, and 5 ml syringes (from Becton, Dickinson and Company, Franklin Lakes, N.J.) with known cross-sectional areas and with theoretical static forces of 5 Newtons, 8 Newtons, or 12 Newtons. As illustrated in the table of FIG. 6, the motive pressure is dependent upon size of the syringe, e.g., the cross-sectional area, and the static force required to initiate movement of the plunger. For example, a 1 ml syringe with a static force of 8 Newtons will require a motive pressure of approximately 66.84 psi.

The method includes defining the push pressure as the greater of the ejection pressure or the motive pressure. In this instance, for a 1 ml syringe with a static force of 8 Newtons for use with the pharmaceutical vial described above, the ejection pressure is approximately 33 psi, while the motive pressure is approximately 67 psi. In this instance, the push pressure is defined as 67 psi.

The method further includes comparing the calculated push pressure with a pressure capacity of the pharmaceutical vial and/or the vial cap with seal. In this instance, 67 psi exceeds the pressure capacity of the vial cap with seal (approximately 45 psi). The user is alerted by the computing device through a display screen alert that the push pressure, i.e., the motive pressure of the chosen syringe, is too great for the vial cap with seal.

The calculations are repeated using a syringe with a volume capacity of 3 milliliters and a static force of 8 Newtons. In this instance a motive pressure of approximately 18.5 psi is reported to the user. In this instance, the motive pressure is less than the ejection pressure and as such the ejection pressure, e.g., approximately 33 psi, is defined as the push pressure. The push pressure is reported to the user through the display screen of the computing device.

### Prophetic Example 2

### Calculating a Molar Amount of Inert Gas

A method of calculating a molar amount of inert gas sufficient to generate calculated push pressure is described herein.

The push pressure is calculated for a given combination of pharmaceutical vial, single dose volume of pharmaceutical, vial cap with seal, and syringe as described in Prophetic Example 1. The molar amount of inert gas in the volume of headspace at atmospheric pressure is proportional to the volume of the headspace. For example, 1 mole of inert gas is the amount of gas at atmospheric pressure in 22.4 liters. Therefore, the molar amount of inert gas in the headspace is the volume of headspace divided by 22.4 liters. For a 0.8 cc headspace, the molar amount of inert gas is 3.57×10⁻⁵ moles. The table in FIG. 17 illustrates the corresponding mass of helium, nitrogen, and argon at different push pressures in the 0.8 cc of headspace. For a headspace of 0.8 cc and a push pressure of 33 psi, e.g., the molar amount of inert gas is approximately 8×10⁻⁵ moles or 3.2×10⁻³ grams of argon, 2.24×10⁻³ grams of nitrogen, or 3.2×10⁻⁴ grams of helium.

### Prophetic Example 3

### Filling a Pharmaceutical Vial with a Single Dose Volume of a Liquid Pharmaceutical and an Inert Gas

A method is described for filling a pharmaceutical vial with a single dose volume of a liquid pharmaceutical, e.g., a vaccine, and a molar amount of inert gas to generate a calculated push pressure is described herein.

Vialing information is accepted by a computer connected to a vialing apparatus from a user interface. The vialing information includes a recommended pharmaceutical vial type, e.g., 2 ml Type 1 borosilicate injection vials from Wheaton, Millville, N.J., for a predetermined single dose volume of liquid pharmaceutical, e.g., 1 ml Hepatitis B vaccine from a World Health Organization approved manufacturer e.g., Shantha Biotechnics Private Ltd, India (see “WHO prequalified vaccines” at http://www.who.int/immunization_standards/vaccine_quality/PQ_vaccine_list_en/en/index.html accessed Jan. 6, 2014, which is incorporated herein by reference). The vialing information further includes a recommended vial cap, e.g., a 13 mm bromobutyl stopper, and a seal, e.g., a 13 mm aluminum seal, both available from Wheaton, Millville, N.J. The vialing information also includes a predetermined molar amount of nitrogen required for a predetermined push pressure. The predetermined push pressure is 33 psi, as calculated in Prophetic Example 1 for a 2 ml pharmaceutical vial for use with a 3 ml syringe with a static force of 8 Newtons. The amount of nitrogen required for a push pressure of 33 psi is approximately 8×10⁻⁵ moles or 2.24×10⁻³ grams of nitrogen, as calculated in Prophetic Example 2.

The 2 ml borosilicate vials are filled with 1 ml of liquid Hepatitis B vaccine under sterile conditions. The bromobutyl stoppers are loosely fitted onto the vials. Sterile filtered nitrogen gas is injected into the volume of headspace above the liquid vaccine to a pressure of 33 psi and the stopper quickly pushed fully into the vial and the stopper affixed to the vial with the aluminum seal using a crimping device.

A laminated paper label is affixed with an adhesive to the outer surface of the filled and sealed 2 ml borosilicate vials. The paper label includes information, e.g., a bar code, regarding the corresponding syringe for use with the vial, e.g., a 3 ml syringe with a static force of approximately 8 Newtons.

Aspects of the subject matter described herein are set out in the following numbered paragraphs:

1. In some embodiments, a method of calculating a push pressure of a pharmaceutical vial with a syringe includes accepting data including at least one parameter of the pharmaceutical vial, the at least one parameter of the pharmaceutical vial including an internal volume of the pharmaceutical vial; accepting data including a single dose volume of a liquid pharmaceutical; accepting data including at least one parameter of a vial cap with a seal, the at least one parameter of the vial cap with the seal including a volume of the vial cap; calculating a volume of headspace over the single dose volume of the liquid pharmaceutical with a computing device; calculating an ejection pressure with the computing device based on the single dose volume of the liquid pharmaceutical and the volume of headspace; accepting data including at least one parameter of the syringe, the at least one parameter of the syringe including a static force and a cross-sectional area of the syringe; calculating a motive pressure with the computing device based on the static force and the cross-sectional area of the syringe; defining the push pressure as the greater of the ejection pressure or the motive pressure; and reporting the push pressure to a user.
2. The method of paragraph 1, further including selecting an inert gas for filling the volume of headspace; calculating with the computing device a molar amount of the inert gas for filling the volume of headspace sufficient to generate the push pressure; and reporting the molar amount of the inert gas to the user.
3. The method of paragraph 2, wherein selecting the inert gas includes selecting at least one of helium, argon, or nitrogen.
4. The method of paragraph 1, wherein accepting the data including the at least one parameter of the pharmaceutical vial includes accepting data including at least one of a maximum pressure capacity, a vial identification code, or an internal surface property.
5. The method of paragraph 1, wherein accepting the data including the at least one parameter of the pharmaceutical vial includes accepting the data from a look-up table.
6. The method of paragraph 1, wherein accepting the data including the at least one parameter of the pharmaceutical vial includes accepting the data from a user input.
7. The method of paragraph 1, wherein accepting the data including the single dose volume of the liquid pharmaceutical includes accepting the data from a look-up table.
8. The method of paragraph 1, wherein accepting the data including the single dose volume of the liquid pharmaceutical includes accepting the data from a user input.
9. The method of paragraph 1, further including comparing the single dose volume of the liquid pharmaceutical to the internal volume of the pharmaceutical vial; and alerting the user if the single dose volume of the liquid pharmaceutical is greater than the internal volume of the pharmaceutical vial.
10. The method of paragraph 1, further including comparing the single dose volume of the liquid pharmaceutical to the internal volume of the pharmaceutical vial; and alerting the user if the single dose volume of the liquid pharmaceutical is greater than a preset percentage of the internal volume of the pharmaceutical vial.
11. The method of paragraph 10, wherein the preset percentage of the internal volume of the pharmaceutical vial includes 80% of the internal volume of the pharmaceutical vial.
12. The method of paragraph 1, wherein accepting the data including the at least one parameter of the vial cap with the seal includes accepting data including at least one of a maximum pressure capacity, a cap identification code, or a surface property of the vial cap with the seal.
13. The method of paragraph 1, wherein accepting the data including the at least one parameter of the vial cap with the seal includes accepting the data from a look-up table.
14. The method of paragraph 1, wherein accepting the data including the at least one parameter of the vial cap with the seal includes accepting the data from a user input.
15. The method of paragraph 1, wherein calculating the volume of headspace over the liquid pharmaceutical with a computing device includes subtracting from the internal volume of the pharmaceutical vial the single dose volume of the liquid pharmaceutical and a portion of the volume of the vial cap intended for positioning adjacent to the internal volume of the pharmaceutical vial.
16. The method of paragraph 1, wherein calculating the ejection pressure with the computing device includes calculating a pressure required in the pharmaceutical vial under a sealed condition to eject the entirety of the single dose volume of the liquid pharmaceutical through a flow path created by the syringe.
17. The method of paragraph 1, wherein accepting the data including the at least one parameter of the syringe includes accepting data including at least one of a volume capacity or a syringe identification code.
18. The method of paragraph 1, wherein accepting the data including the at least one parameter of the syringe includes accepting data including at least one parameter of a syringe with a volume capacity greater than the single dose volume of the liquid pharmaceutical.
19. The method of paragraph 1, wherein accepting the data including the at least one parameter of the syringe includes accepting data including at least one parameter of a syringe listed on a look-up table.
20. The method of paragraph 1, wherein calculating the motive pressure with the computing device based on the static force and the cross-sectional area of the syringe includes calculating a pressure proportional to the cross-sectional area of the syringe and sufficient to overcome the static force required to initiate movement of a plunger of the syringe.
21. The method of paragraph 1, further including comparing the single dose volume of the liquid pharmaceutical with a volume capacity of the syringe; and alerting the user if the single dose volume of the liquid pharmaceutical is greater than the volume capacity of the syringe.
22. The method of paragraph 1, further including comparing the push pressure with a maximum pressure capacity of the pharmaceutical vial; and alerting the user if the push pressure is greater than the maximum pressure capacity of the pharmaceutical vial.
23. The method of paragraph 22, further including selecting a second pharmaceutical vial with a different internal volume; accepting data including the different internal volume of the second pharmaceutical vial; and calculating an ejection pressure for the second pharmaceutical vial with the computing device.
24. The method of paragraph 22, further including selecting a second syringe with a different static force and cross-sectional area; accepting data including the different static force and cross-sectional area of the second syringe; and calculating a motive pressure for the second syringe.
25. The method of paragraph 1, further including comparing the push pressure with a maximum pressure capacity of the vial cap with the seal; and alerting the user if the push pressure is greater than the maximum pressure capacity of the vial cap with the seal.
26. The method of paragraph 1, wherein defining the push pressure includes defining the push pressure as the greater of the ejection pressure or the motive pressure plus a preset percentage of added pressure.
27. The method of paragraph 1, wherein reporting the push pressure to the user includes reporting the push pressure on a display screen of the computing device.
28. The method of paragraph 1, wherein reporting the push pressure to the user includes reporting the push pressure to a controller operably coupled to a vialing apparatus.
29. In some embodiments, a system for calculating a push pressure of a pharmaceutical vial with a syringe includes circuitry for accepting data including at least one parameter of the pharmaceutical vial, the at least one parameter of the pharmaceutical vial including an internal volume of the pharmaceutical vial; circuitry for accepting data including a single dose volume of a liquid pharmaceutical; circuitry for accepting data including at least one parameter of a vial cap with a seal, the at least one parameter of the vial cap with the seal including a volume of the vial cap; circuitry for calculating a volume of headspace over the single dose volume of the liquid pharmaceutical; circuitry for calculating an ejection pressure based on the single dose volume of the liquid pharmaceutical and the volume of headspace; circuitry for accepting data including at least one parameter of the syringe, the at least one parameter of the syringe including a static force and a cross-sectional area of the syringe; circuitry for calculating a motive pressure based on the static force and the cross-sectional area of the syringe; circuitry for defining the push pressure as the greater of the ejection pressure or the motive pressure; and circuitry for sending a signal to report the push pressure to a user.
30. The system of paragraph 29, further including circuitry for selecting an inert gas for filling the volume of headspace; circuitry for calculating a molar amount of the inert gas for filling the volume of headspace sufficient to generate the push pressure; and circuitry for sending a signal to report the molar amount of the inert gas to the user.
31. The system of paragraph 29, further including a computing device.
32. The system of paragraph 29, wherein the circuitry for accepting the data including the at least one parameter of the pharmaceutical vial includes circuitry for accepting data including at least one of a maximum pressure capacity, a vial identification code, or an internal surface property.
33. The system of paragraph 29, wherein the circuitry for accepting the data including the at least one parameter of the pharmaceutical vial includes circuitry for accepting the data from a look-up table.
34. The system of paragraph 29, wherein the circuitry for accepting the data including the at least one parameter of the pharmaceutical vial includes circuitry for accepting the data from a user input.
35. The system of paragraph 29, wherein the circuitry accepting the data including the single dose volume of the liquid pharmaceutical includes circuitry for accepting the data from a look-up table.
36. The system of paragraph 29, wherein the circuitry accepting the data including the single dose volume of the liquid pharmaceutical includes circuitry for accepting the data from a user input.
37. The system of paragraph 29, further including circuitry for comparing the single dose volume of the liquid pharmaceutical to the internal volume of the pharmaceutical vial; and circuitry for alerting the user if the single dose volume of the liquid pharmaceutical is greater than the internal volume of the pharmaceutical vial.
38. The system of paragraph 29, further including circuitry for comparing the single dose volume of the liquid pharmaceutical to the internal volume of the pharmaceutical vial; and circuitry for alerting the user if the single dose volume of the liquid pharmaceutical is greater than a preset percentage of the internal volume of the pharmaceutical vial.
39. The system of paragraph 38, wherein the preset percentage of the internal volume of the pharmaceutical vial includes 80% of the internal volume of the pharmaceutical vial.
40. The system of paragraph 29, wherein the circuitry for accepting the data including the at least one parameter of the vial cap with the seal includes circuitry for accepting data including at least one of a maximum pressure capacity, a cap identification code, or a surface property of the vial cap with the seal.
41. The system of paragraph 29, wherein the circuitry for accepting the data including the at least one parameter of the vial cap with the seal includes circuitry for accepting the data from a look-up table.
42. The system of paragraph 29, wherein the circuitry for accepting the data including the at least one parameter of the vial cap with the seal includes circuitry for accepting the data from a user input.
43. The system of paragraph 29, wherein the circuitry for calculating the volume of headspace over the liquid pharmaceutical includes circuitry for subtracting from the internal volume of the pharmaceutical vial the single dose volume of the liquid pharmaceutical and a portion of the volume of the vial cap intended for positioning adjacent to the internal volume of the pharmaceutical vial.
44. The system of paragraph 29, wherein the circuitry for calculating the ejection pressure includes circuitry for calculating a pressure required in the pharmaceutical vial under a sealed condition to eject the entirety of the single dose volume of the liquid pharmaceutical through a flow path created by the syringe.
45. The system of paragraph 29, wherein the circuitry for accepting the data including the at least one parameter of the syringe includes circuitry for accepting data including at least one of a volume capacity or a syringe identification code.
46. The system of paragraph 29, wherein the circuitry for accepting the data including the at least one parameter of the syringe includes circuitry for accepting data including at least one parameter of a syringe with a volume capacity greater than the single dose volume of the liquid pharmaceutical.
47. The system of paragraph 29, wherein the circuitry for accepting the data including the at least one parameter of the syringe includes circuitry for accepting data including at least one parameter of a syringe listed on a look-up table.
48. The system of paragraph 29, wherein the circuitry for calculating the motive pressure with the computing device based on the static force and the cross-sectional area of the syringe includes circuitry for calculating a pressure proportional to the cross-sectional area of the syringe and sufficient to overcome the static force required to initiate movement of a plunger of the syringe.
49. The system of paragraph 29, further including circuitry for comparing the single dose volume of the liquid pharmaceutical with a volume capacity of the syringe; and circuitry for alerting the user if the single dose volume of the liquid pharmaceutical is greater than the volume capacity of the syringe.
50. The system of paragraph 29, further including circuitry for comparing the calculated push pressure with a maximum pressure capacity of the pharmaceutical vial; and circuitry for alerting the user if the calculated push pressure is greater than the maximum pressure capacity of the pharmaceutical vial.
51. The system of paragraph 50, further including circuitry for selecting a second pharmaceutical vial with a different internal volume; circuitry for accepting data including the different internal volume of the second pharmaceutical vial; and circuitry for calculating an ejection pressure for the second pharmaceutical vial.
52. The system of paragraph 50, further including circuitry for selecting a second syringe with a different static force and cross-sectional area; circuitry for accepting data including the different static force and cross-sectional area of the second syringe; and circuitry for calculating a motive pressure for the second syringe.
53. The system of paragraph 29, further including circuitry for comparing the calculated push pressure with a maximum pressure capacity of the vial cap with the seal; and circuitry for alerting the user if the calculated push pressure is greater than the maximum pressure capacity of the vial cap with the seal.
54. The system of paragraph 29, wherein the circuitry for defining the push pressure includes circuitry for defining the push pressure as the greater of the ejection pressure or the motive pressure plus a preset percentage of added pressure.
55. The system of paragraph 29, wherein the circuitry for sending the signal to report the push pressure to the user includes circuitry for sending a signal to report the push pressure on a display screen of the computing device.
56. The system of paragraph 29, wherein the circuitry for sending the signal to report the push pressure to the user includes circuitry for sending a signal to report the push pressure to a controller operably coupled to a vialing apparatus.
57. In some embodiments, a method of filling a pharmaceutical vial includes accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal; filling the recommended pharmaceutical vial with the predetermined single dose volume of the liquid pharmaceutical; injecting the predetermined molar amount of the inert gas into a volume of headspace above the predetermined single dose volume of the liquid pharmaceutical; and sealing the filled recommended pharmaceutical vial with the recommended vial cap with seal to maintain the predetermined push pressure within the filled recommended pharmaceutical vial.
58. The method of paragraph 57, wherein accepting the data including the vialing information includes accepting the data from at least one look-up table.
59. The method of paragraph 57, wherein accepting the data including the vialing information includes accepting the data from a user input.
60. The method of paragraph 57, wherein accepting the data including the vialing information includes accepting the data from a computing device.
61. The method of paragraph 57, wherein accepting the data including the vialing information includes accepting the data including the vialing information into a controller operably coupled to a vialing apparatus.
62. The method of paragraph 57, wherein filling the recommended pharmaceutical vial with the predetermined single dose volume of the liquid pharmaceutical includes filling the recommended pharmaceutical vial with a predetermined single dose volume of the liquid pharmaceutical that is less than or equal to a preset percentage of an internal volume of the recommended pharmaceutical vial.
63. The method of paragraph 57, wherein filling the recommended pharmaceutical vial with the predetermined single dose volume of the liquid pharmaceutical includes filling the recommended pharmaceutical vial with a predetermined single dose volume of the liquid pharmaceutical that is 80% or less of an internal volume of the recommended pharmaceutical vial.
64. The method of paragraph 57, wherein filling the recommended pharmaceutical vial includes filling the recommended pharmaceutical vial using an automated vialing apparatus including a controller.
65. The method of paragraph 57, wherein injecting the predetermined molar amount of the inert gas includes injecting a predetermined molar amount of argon.
66. The method of paragraph 57, wherein injecting the predetermined molar amount of the inert gas includes injecting a predetermined molar amount of helium.
67. The method of paragraph 57, wherein injecting the predetermined molar amount of the inert gas includes injecting a predetermined molar amount of nitrogen.
68. The method of paragraph 57, wherein injecting the predetermined molar amount of the inert gas into the volume of headspace includes injecting the predetermined molar amount of the inert gas directly into the volume of headspace.
69. The method of paragraph 57, wherein injecting the predetermined molar amount of the inert gas into the volume of headspace includes injecting the predetermined molar amount of the inert gas indirectly into the volume of headspace by equilibrating the recommended pharmaceutical vial in a sealed vialing apparatus in an atmosphere including the inert gas.
70. The method of paragraph 57, further including injecting at least a portion of the predetermined molar amount of inert gas into the volume of headspace after sealing the recommended pharmaceutical vial with the vial cap with seal; and resealing the vial cap with seal with an energy source to maintain the push pressure in the recommended pharmaceutical vial.
71. The method of paragraph 57, further including labeling the recommended pharmaceutical vial to include a recommended syringe type.
72. The method of paragraph 71, wherein labeling the recommended pharmaceutical vial to include a recommended syringe type includes labeling the recommended pharmaceutical vial with a vial code to match a syringe code.
73. The method of paragraph 72, wherein labeling the recommended pharmaceutical vial with a vial code to match a syringe code includes labeling the recommended pharmaceutical vial with at least one of a color, a bar code, or an RFID tag to match the syringe code.
74. In some embodiments, a method of filling a pharmaceutical vial includes accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal; filling the recommended pharmaceutical vial with the predetermined single dose volume of the liquid pharmaceutical; affixing the recommended vial cap to the filled recommended pharmaceutical vial with the seal; injecting the predetermined molar amount of the inert gas through a needle-penetrable portion of the affixed vial cap and into a volume of headspace above the predetermined single dose volume of the liquid pharmaceutical; and sealing the needle-penetrable portion of the affixed recommended vial cap to maintain the predetermined push pressure within the filled recommended pharmaceutical vial.
75. The method of paragraph 74, wherein accepting the data including the vialing information includes accepting the data from at least one look-up table.
76. The method of paragraph 74, wherein accepting the data including the vialing information includes accepting the data from a user input.
77. The method of paragraph 74, wherein accepting the data including the vialing information includes accepting the data from a computing device.
78. The method of paragraph 74, wherein accepting the data including the vialing information includes accepting the data including the vialing information into a controller operably coupled to a vialing apparatus.
79. The method of paragraph 74, wherein filling the recommended pharmaceutical vial with the predetermined single dose volume of the liquid pharmaceutical includes filling the recommended pharmaceutical vial with a predetermined single dose volume of the liquid pharmaceutical that is less than or equal to a preset percentage of an internal volume of the recommended pharmaceutical vial.
80. The method of paragraph 74, wherein filling the recommended pharmaceutical vial with the predetermined single dose volume of the liquid pharmaceutical includes filling the recommended pharmaceutical vial with a predetermined single dose volume of the liquid pharmaceutical that is 80% or less of an internal volume of the recommended pharmaceutical vial.
81. The method of paragraph 74, wherein filling the recommended pharmaceutical vial includes filling the recommended pharmaceutical vial using an automated vialing apparatus operably coupled to a controller.
82. The method of paragraph 74, wherein injecting the predetermined molar amount of the inert gas through a needle-penetrable portion of the vial cap includes injecting a predetermined molar amount of argon through a needle-penetrable portion of the vial cap.
83. The method of paragraph 74, wherein injecting the predetermined molar amount of the inert gas through a needle-penetrable portion of the vial cap includes injecting a predetermined molar amount of helium through a needle-penetrable portion of the vial cap.
84. The method of paragraph 74, wherein injecting the predetermined molar amount of the inert gas through a needle-penetrable portion of the vial cap includes injecting a predetermined molar amount of nitrogen through a needle-penetrable portion of the vial cap.
85. The method of paragraph 74, wherein sealing the needle-penetrable portion includes sealing the needle-penetrable portion with a thermal energy source.
86. The method of paragraph 74, further including labeling the recommended pharmaceutical vial to include a recommended syringe type.
87. The method of paragraph 86, wherein labeling the recommended pharmaceutical vial to include a recommended syringe type includes labeling the recommended pharmaceutical vial with a vial code to match a syringe code.
88. The method of paragraph 87, wherein labeling the recommended pharmaceutical vial with a vial code to match a syringe code includes labeling the recommended pharmaceutical vial with at least one of a color, a bar code, or an RFID tag to match the syringe code.
89. In some embodiments, a method of filling pharmaceutical vials with an automated vialing apparatus includes selecting a pharmaceutical vial for a predetermined single dose volume of a liquid pharmaceutical from a list of recommended pharmaceutical vials; placing the selected pharmaceutical vial in a filling station of the automated vialing apparatus; filling the selected pharmaceutical vial with the predetermined single dose volume of the liquid pharmaceutical; selecting a molar amount of an inert gas for a recommended push pressure for the selected pharmaceutical vial and a syringe; filling a volume of headspace above the predetermined single dose volume of the liquid pharmaceutical in the selected pharmaceutical vial with the molar amount of the inert gas for the recommended push pressure; selecting a vial cap with seal for the selected pharmaceutical vial from a list of recommended vial caps with seals; and sealing the selected pharmaceutical vial with the selected vial cap with seal to maintain the recommended push pressure within the pharmaceutical vial.
90. This application uses automatic claim numbering. Please do not change claim numbering manually.
In some embodiments, pharmaceutical vial filled for use with a syringe includes a single dose volume of a liquid pharmaceutical; a cap including a needle-penetrable portion; a volume of headspace above the single dose volume of the liquid pharmaceutical and below the cap, a molar amount of inert gas in the volume of headspace, the molar amount of inert gas proportional to a push pressure for the pharmaceutical vial and the syringe; and a seal fitted over a portion of the cap to secure the cap to the pharmaceutical vial and to maintain the push pressure in the volume of headspace.
91. The pharmaceutical vial of paragraph 90, wherein the liquid pharmaceutical includes at least one vaccine.
92. The pharmaceutical vial of paragraph 90, wherein the liquid pharmaceutical includes at least one therapeutic agent.
93. The pharmaceutical vial of paragraph 90, wherein the single dose volume of the liquid pharmaceutical is less than or equal to a preset percentage of an internal volume of the pharmaceutical vial.
94. The pharmaceutical vial of paragraph 90, wherein the single dose volume of the liquid pharmaceutical is less than or equal to 80% of an internal volume of the pharmaceutical vial.
95. The pharmaceutical vial of paragraph 90, wherein the cap including the needle-penetrable portion includes a rubber stopper.
96. The pharmaceutical vial of paragraph 90, wherein the cap including the needle-penetrable portion includes a septum.
97. The pharmaceutical vial of paragraph 90, wherein the cap including the needle-penetrable portion is resealable.
98. The pharmaceutical vial of paragraph 90, wherein the needle-penetrable portion is thermal-responsive.
99. The pharmaceutical vial of paragraph 90, wherein the volume of headspace includes a preset percentage of an internal volume of the pharmaceutical vial.
100. The pharmaceutical vial of paragraph 90, wherein the volume of headspace includes at least 20% of an internal volume of the pharmaceutical vial.
101. The pharmaceutical vial of paragraph 90, wherein the molar amount of inert gas is proportional to the single dose volume of the liquid pharmaceutical and the volume of headspace.
102. The pharmaceutical vial of paragraph 90, wherein the molar amount of inert gas includes a molar amount of nitrogen.
103. The pharmaceutical vial of paragraph 90, wherein the molar amount of inert gas includes a molar amount of argon.
104. The pharmaceutical vial of paragraph 90, wherein the push pressure includes a pressure greater than atmospheric pressure.
105. The pharmaceutical vial of paragraph 90, wherein the push pressure includes a pressure less than or equal to a maximum pressure capacity of one or more of the pharmaceutical vial, the cap, or the seal.
106. The pharmaceutical vial of paragraph 90, wherein the push pressure includes an ejection pressure sufficient to eject the single dose volume of the liquid pharmaceutical into the syringe.
107. The pharmaceutical vial of paragraph 90, wherein the push pressure includes a motive pressure sufficient to move a plunger of the syringe.
108. The pharmaceutical vial of paragraph 90, wherein the push pressure includes the greater of an ejection pressure sufficient to eject the single dose volume of the liquid pharmaceutical into the syringe or a motive pressure sufficient to move a plunger associated with the syringe.
109. The pharmaceutical vial of paragraph 90, wherein the seal includes a crimp seal.
110. The pharmaceutical vial of paragraph 90, further including a label including a recommended syringe type.
111. The pharmaceutical vial of paragraph 110, wherein the label includes a vial code to match a syringe code.
112. The pharmaceutical vial of paragraph 111, wherein the vial code to match the syringe code includes at least one of a color code, a bar code, or an RFID tag.
113. The pharmaceutical vial of paragraph 90, further including a removable lid sized to fit securely over at least a portion of the vial cap.

All of the above U.S. patents, U.S. patent application publications, U.S. patent applications, foreign patents, foreign patent applications and non-patent publications referred to in this specification and/or listed in any Application Data Sheet, including but not limited to [insert list], are incorporated herein by reference, to the extent not inconsistent herewith.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of calculating a push pressure of a pharmaceutical vial with a syringe comprising:
accepting data including at least one parameter of the pharmaceutical vial, the at least one parameter of the pharmaceutical vial including an internal volume of the pharmaceutical vial;
accepting data including a single dose volume of a liquid pharmaceutical;
accepting data including at least one parameter of a vial cap with a seal, the at least one parameter of the vial cap with the seal including a volume of the vial cap;
calculating a volume of headspace over the single dose volume of the liquid pharmaceutical with a computing device;
calculating an ejection pressure with the computing device based on the single dose volume of the liquid pharmaceutical and the volume of headspace;
accepting data including at least one parameter of the syringe, the at least one parameter of the syringe including a static force and a cross-sectional area of the syringe;
calculating a motive pressure with the computing device based on the static force and the cross-sectional area of the syringe;
defining the push pressure as the greater of the ejection pressure or the motive pressure; and
reporting the push pressure to a user.

2. The method of claim 1, further comprising:
selecting an inert gas for filling the volume of headspace;
calculating with the computing device a molar amount of the inert gas for filling the volume of headspace sufficient to generate the push pressure; and
reporting the molar amount of the inert gas to the user.

3.-9. (canceled)

10. The method of claim 1, further comprising:
comparing the single dose volume of the liquid pharmaceutical to the internal volume of the pharmaceutical vial; and
alerting the user if the single dose volume of the liquid pharmaceutical is greater than a preset percentage of the internal volume of the pharmaceutical vial.

11.-14. (canceled)

15. The method of claim 1, wherein calculating the volume of headspace over the liquid pharmaceutical with the computing device comprises subtracting from the internal volume of the pharmaceutical vial the single dose volume of the liquid pharmaceutical and a portion of the volume of the vial cap intended for positioning adjacent to the internal volume of the pharmaceutical vial.

16. The method of claim 1, wherein calculating the ejection pressure with the computing device comprises calculating a pressure required in the pharmaceutical vial under a sealed condition to eject the entirety of the single dose volume of the liquid pharmaceutical through a flow path created by the syringe.

17.-19. (canceled)

20. The method of claim 1, wherein calculating the motive pressure with the computing device based on the static force and the cross-sectional area of the syringe comprises calculating a pressure proportional to the cross-sectional area of the syringe and sufficient to overcome the static force required to initiate movement of a plunger of the syringe.

21. (canceled)

22. The method of claim 1, further comprising:
comparing the push pressure with a maximum pressure capacity of the pharmaceutical vial; and
alerting the user if the push pressure is greater than the maximum pressure capacity of the pharmaceutical vial.

23.-24. (canceled)

25. The method of claim 1, further comprising:
comparing the push pressure with a maximum pressure capacity of the vial cap with the seal; and
alerting the user if the push pressure is greater than the maximum pressure capacity of the vial cap with the seal.

26. The method of claim 1, wherein defining the push pressure comprises defining the push pressure as the greater of the ejection pressure or the motive pressure plus a preset percentage of added pressure.

27.-28. (canceled)

29. A system for calculating a push pressure of a pharmaceutical vial with a syringe comprising:
circuitry for accepting data including at least one parameter of the pharmaceutical vial, the at least one parameter of the pharmaceutical vial including an internal volume of the pharmaceutical vial;
circuitry for accepting data including a single dose volume of a liquid pharmaceutical;
circuitry for accepting data including at least one parameter of a vial cap with a seal, the at least one parameter of the vial cap with the seal including a volume of the vial cap;
circuitry for calculating a volume of headspace over the single dose volume of the liquid pharmaceutical;
circuitry for calculating an ejection pressure based on the single dose volume of the liquid pharmaceutical and the volume of headspace;
circuitry for accepting data including at least one parameter of the syringe, the at least one parameter of the syringe including a static force and a cross-sectional area of the syringe;
circuitry for calculating a motive pressure based on the static force and the cross-sectional area of the syringe;
circuitry for defining the push pressure as the greater of the ejection pressure or the motive pressure; and
circuitry for sending a signal to report the push pressure to a user.

30. The system of claim 29, further comprising:
circuitry for selecting an inert gas for filling the volume of headspace;
circuitry for calculating a molar amount of the inert gas for filling the volume of headspace sufficient to generate the push pressure; and
circuitry for sending a signal to report the molar amount of the inert gas to the user.

31. The system of claim 29, further comprising:
a computing device.

32.-37. (canceled)

38. The system of claim 29, further comprising:
circuitry for comparing the single dose volume of the liquid pharmaceutical to the internal volume of the pharmaceutical vial; and
circuitry for alerting the user if the single dose volume of the liquid pharmaceutical is greater than a preset percentage of the internal volume of the pharmaceutical vial.

39.-42. (canceled)

43. The system of claim 29, wherein the circuitry for calculating the volume of headspace over the liquid pharmaceutical comprises circuitry for subtracting from the internal volume of the pharmaceutical vial the single dose volume of the liquid pharmaceutical and a portion of the volume of the vial cap intended for positioning adjacent to the internal volume of the pharmaceutical vial.

44. The system of claim 29, wherein the circuitry for calculating the ejection pressure comprises circuitry for calculating a pressure required in the pharmaceutical vial under a sealed condition to eject the entirety of the single dose volume of the liquid pharmaceutical through a flow path created by the syringe.

45.-47. (canceled)

48. The system of claim 29, wherein the circuitry for calculating the motive pressure with the computing device based on the static force and the cross-sectional area of the syringe comprises circuitry for calculating a pressure proportional to the cross-sectional area of the syringe and sufficient to overcome the static force required to initiate movement of a plunger of the syringe.

49. (canceled)

50. The system of claim 29, further comprising:
circuitry for comparing the calculated push pressure with a maximum pressure capacity of the pharmaceutical vial; and
circuitry for alerting the user if the calculated push pressure is greater than the maximum pressure capacity of the pharmaceutical vial.

51.-52. (canceled)

53. The system of claim 29, further comprising:
circuitry for comparing the calculated push pressure with a maximum pressure capacity of the vial cap with the seal; and
circuitry for alerting the user if the calculated push pressure is greater than the maximum pressure capacity of the vial cap with the seal.

54. The system of claim 29, wherein the circuitry for defining the push pressure comprises circuitry for defining the push pressure as the greater of the ejection pressure or the motive pressure plus a preset percentage of added pressure.

55.-56. (canceled)

57. A method of filling a pharmaceutical vial comprising:
accepting data including vialing information, the vialing information including a recommended pharmaceutical vial for a predetermined single dose volume of a liquid pharmaceutical, a predetermined molar amount of an inert gas for a predetermined push pressure, and a recommended vial cap with seal;
filling the recommended pharmaceutical vial with the predetermined single dose volume of the liquid pharmaceutical;
injecting the predetermined molar amount of the inert gas into a volume of headspace above the predetermined single dose volume of the liquid pharmaceutical; and
sealing the filled recommended pharmaceutical vial with the recommended vial cap with seal to maintain the predetermined push pressure within the filled recommended pharmaceutical vial.

58.-60. (canceled)

61. The method of claim 57, wherein accepting the data including the vialing information comprises accepting the data including the vialing information into a controller operably coupled to a vialing apparatus.

62. The method of claim 57, wherein filling the recommended pharmaceutical vial with the predetermined single dose volume of the liquid pharmaceutical comprises filling the recommended pharmaceutical vial with a predetermined single dose volume of the liquid pharmaceutical that is less than or equal to a preset percentage of an internal volume of the recommended pharmaceutical vial.

63. (canceled)

64. The method of claim 61, wherein filling the recommended pharmaceutical vial comprises filling the recommended pharmaceutical vial using the vialing apparatus.

65.-67. (canceled)

68. The method of claim 57, wherein injecting the predetermined molar amount of the inert gas into the volume of headspace comprises injecting the predetermined molar amount of the inert gas directly into the volume of headspace.

69. The method of claim 57, wherein injecting the predetermined molar amount of the inert gas into the volume of headspace comprises injecting the predetermined molar amount of the inert gas indirectly into the volume of headspace by equilibrating the recommended pharmaceutical vial in a sealed vialing apparatus in an atmosphere including the inert gas.

70. (canceled)

71. The method of claim 57 further comprising:
labeling the recommended pharmaceutical vial to include a recommended syringe type.

72.-73. (canceled)

74. The method of claim 57, further comprising:
filling the recommended pharmaceutical vial with the predetermined single dose volume of the liquid pharmaceutical;
affixing the recommended vial cap to the filled recommended pharmaceutical vial with the seal;
injecting the predetermined molar amount of the inert gas through a needle-penetrable portion of the affixed vial cap and into the volume of headspace above the predetermined single dose volume of the liquid pharmaceutical; and
sealing the needle-penetrable portion of the affixed recommended vial cap to maintain the predetermined push pressure within the filled recommended pharmaceutical vial.

75.-84. (canceled)

85. The method of claim 74, wherein sealing the needle-penetrable portion comprises sealing the needle-penetrable portion with a thermal energy source.

86.-88. (canceled)

89. A pharmaceutical vial filled for use with a syringe comprising:
a single dose volume of a liquid pharmaceutical;
a cap including a needle-penetrable portion;
a volume of headspace above the single dose volume of the liquid pharmaceutical and below the cap,
a molar amount of inert gas in the volume of headspace, the molar amount of inert gas proportional to a push pressure for the pharmaceutical vial and the syringe; and
a seal fitted over a portion of the cap to secure the cap to the pharmaceutical vial and to maintain the push pressure in the volume of headspace.

90.-92. (canceled)

93. The pharmaceutical vial of claim 89, wherein the single dose volume of the liquid pharmaceutical is less than or equal to 80% of an internal volume of the pharmaceutical vial.

94.-95. (canceled)

96. The pharmaceutical vial of claim 89, wherein the needle-penetrable portion is resealable.

97. (canceled)

98. The pharmaceutical vial of claim 89, wherein the volume of headspace comprises a preset percentage of an internal volume of the pharmaceutical vial.

99. (canceled)

100. The pharmaceutical vial of claim 89, wherein the molar amount of inert gas is proportional to the single dose volume of the liquid pharmaceutical and the volume of headspace.

101. The pharmaceutical vial of claim 89, wherein the molar amount of inert gas comprises a molar amount of nitrogen.

102. The pharmaceutical vial of claim 89, wherein the molar amount of inert gas comprises a molar amount of argon.

103. The pharmaceutical vial of claim 89, wherein the push pressure comprises a pressure greater than atmospheric pressure and less than or equal to a maximum pressure capacity of one or more of the pharmaceutical vial, the cap, or the seal.

104.-106. (canceled)

107. The pharmaceutical vial of claim 89, wherein the push pressure comprises the greater of an ejection pressure sufficient to eject the single dose volume of the liquid pharmaceutical into the syringe or a motive pressure sufficient to move a plunger associated with the syringe.

108. (canceled)

109. The pharmaceutical vial of claim 89, further comprising:
a label including a recommended syringe type.

110.-112. (canceled)
